(19) United States
(12) Patent Application Publication
(10) Pub. No.: US 2025/0093793 A1
(43) Pub. Date: Mar. 20, 2025

(54) TONER

(71) Applicant: CANON KABUSHIKI KAISHA, Tokyo (JP)

(72) Inventors: YOSHIAKI SHIOTARI, Shizuoka (JP); KOZUE URATANI, Shizuoka (JP); KOKI INOUE, Shizuoka (JP)

(21) Appl. No.: 18/885,386

(22) Filed: Sep. 13, 2024

(30) Foreign Application Priority Data
Sep. 19, 2023 (JP) 2023-151562

(51) Int. Cl. G03G 9/093

(52) U.S. Cl. CPC G03G 9/09328

(57) ABSTRACT

A toner includes: a toner particle, in which the toner particle includes a toner base particle that contains a binder resin and a colorant, and a silicon-titanium polymer composite existing on a surface of the toner base particle, the silicon-titanium polymer composite contains a silicon polymer segment and a titanium chelate segment, the silicon-titanium polymer composite has a peak attributed to Ti—O—Si stretching vibration measured by infrared spectroscopy, and when the proportion of the number of atoms of titanium atoms obtained by X-ray photoelectron spectroscopy analysis on the toner is taken as Ti-E, and the proportion of the number of atoms of silicon atoms is taken as Si-E, the Ti-E and the Si-E satisfy a specific relationship.

### BACKGROUND OF THE INVENTION

### Field of the Invention

The present disclosure relates to a toner used for a recording method utilizing electrophotography, electrostatic recording, and toner jet recording.

### Description of the Related Art

Methods for visualizing image information through electrostatic latent images, such as electrophotography, are applied to copiers, multifunction printers, and printers, and in recent years, further cost reduction and higher image quality have been demanded. Among them, the required image quality level is increasing every year, regardless of print speed, and toners that can achieve higher image quality have been demanded. Furthermore, as the global market for printers expands, printers are used in a variety of environments, and performances that can maintain high image quality have also been demanded in a variety of environments.

Toners are transported onto a toner carrying member and then triboelectrically charged when the toners are rubbed against the charge-providing member. After that, the toners fly from the toner carrying member to an electrostatic latent image on an electrostatic latent image bearing member (hereinafter referred to as an electrophotographic photoreceptor or a photoreceptor) by electrostatic force.

In order to improve image quality, latent images are required to be faithfully reproduced by toners; therefore, precise control of toner charging is required. If the control of toner charging is insufficient, various failures occur, such as fog caused by low-charged toner being developed in non-image areas, fog caused by poor regulation of toners on a toner transfer member due to overcharged toner firmly adhering to a toner carrying member, and image density changes caused by changes in toner charge quantity between the initial and final stages of prints, which interrupts faithful reproduction of latent images.

Conventionally, as a method for controlling toner charge, a technique using an inorganic fine particle having high insulating properties, such as silica, together with an inorganic fine particle having low insulating properties, such as titania, as external additives and uniformly adhering these inorganic fine particles on the toner particle surface to improve the flowability of the toner, making charge uniform, has been employed. However, there were concerns about the degradation of charge characteristics of the like due to continuous use or neglect under high-temperature and high-humidity environments.

In order to solve the above problems, a silica-titania composite particle having both properties of silica and titania is used in Japanese Patent Application Publication No. 2011-118210. In Japanese Patent Application Publication No. 2014-021214, a silica composite particle containing silicon oxide and titanium is used. Furthermore, in Japanese Patent Application Publication No. 2019-128515, composite particles of all metal elements belonging to groups 3 to 13 and organic silicon compounds are used. As such, methods for controlling the toner charge have been proposed.

### SUMMARY OF THE INVENTION

For example, in Japanese Patent Application Publication No. 2011-118210, titania has a core-shell structure coated with silica, which controls the zeta potential, improves the maintenance and charge rising performance, and suppresses fog. However, the toner disclosed in Japanese Patent Application Publication No. 2011-118210 has a large amount of titania added and is thus prone to generate excessive conductive paths. Thus, a printer with a slow print speed causes electric charge leakage due to conductive paths, and the charge quantities differ greatly between the beginning and the end of the continuous print run and, as a result, image density fluctuations due to the charge may occur.

In Japanese Patent Application Publication No. 2014-021214, the use of deformed composite particles of silicon oxide and titanium elements suppresses the migration of the composite particles from the toner to the member and improves density fluctuations and fog. However, since the toner in Japanese Patent Application Publication No. 2014-021214 has a large amount of exposed titanium elements on the surface, there remains an issue of fog under a high-temperature and high-humidity environment.

In Japanese Patent Application Publication No. 2019-128515, due to the uneven distribution of metal atoms, derived from a polyhydric acid metal salt, on the outermost surface of the toner, many moisture adsorption sites exist, and the exposed polyhydric acid metal salt acts as a charge leakage point. Therefore, the leakage control of charges is not enough to support faster process speeds under a high-temperature and high-humidity environment, and sufficient charge performance may not be achieved for the suppression of fog in a high-temperature and high-humidity environment.

In all inventions described above, the problems of density fluctuations and fog in a severe environment regardless of print speed have not all been solved simultaneously, and therefore, further toner charge control techniques have been demanded.

The present disclosure directs to a toner with stable charge characteristics regardless of printing speed and environment, and less image fog, and moreover an ability to provide printed matters with low density fluctuations and low color appearance fluctuations from the first to the last prints.

The present disclosure is related to a toner comprising a toner particle,
the toner particle comprising
a toner base particle that comprises a binder resin and a colorant; and
a silicon-titanium polymer composite existing on a surface of the toner base particle,
the silicon-titanium polymer composite comprising a silicon polymer segment and a titanium chelate segment,
the silicon-titanium polymer composite having a peak within a range of 900 cm⁻¹ to 1000 cm⁻¹ attributed to Ti—O—Si stretching vibration in a spectrum obtained by infrared spectroscopy,
when a proportion of the number of the titanium atom in a sum of the numbers of a carbon atom, an oxygen atom, a silicon atom, a phosphorous atom, and the titanium atom obtained by X-ray photoelectron spectroscopy on the toner is defined as Ti-E, and a proportion of a number of the silicon atom in a sum of the numbers of a carbon atom, an oxygen atom, a silicon atom, a phosphorous atom, and the titanium atom obtained by X-ray photoelectron spectroscopy on the toner is defined as Si-E,
the Ti-E and the Si-E satisfying Formulas (1) and (2) below:

$$1.0 \times 1 {0}^{- 3} \leq Ti - E \leq 2.5 \times 1 {0}^{- 2} \qquad ( 1 )$$

$$1. \times 1 {0}^{- 2} \leq Ti - E / Si - E \leq 7.0 \times 1 {0}^{- 2} . \qquad ( 2 )$$

The present disclosure can provide a toner with stable charge characteristics regardless of printing speed and environment, less image fog, and an ability to provide printed matters with low density fluctuations and low color appearance fluctuations from the first to the last prints.

Further features of the present invention will become apparent from the following description of exemplary embodiments.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, a plurality of constituents may be selected from XX, and the same applies to YY and ZZ.

Hereinafter, the present disclosure will be described in detail.

The toner of the present disclosure is characterized by containing, as a toner particle, a silicon-titanium polymer composite in which silicon polymer segments and titanium chelate segments are chemically bonded and the titanium chelate segments are covered with the silicon polymer segments at a certain level. In the spectrum obtained by infrared spectroscopy, coupling between the silicon polymer segments and the titanium chelate segments can be observed by confirming the presence of a peak within the range of 900 cm⁻¹ to 1000 cm⁻¹ attributed to Ti—O—Si stretching vibration. Furthermore, it is believed that the titanium chelate segments are covered with the silicon polymer segments at a certain level if Formulas (1) and (2) mentioned below are satisfied.

Since a silicon polymer compound has a high volume resistance, charges accumulate due to friction and external electric fields, which may cause overcharging of toners. Meanwhile, the titanium chelate has a structure in which titanium and a chelate form a crosslinking structure. The chelate is prone to receive electron pairs and be charged negatively, and the crosslinking structure facilitates the movement of electrons. Thus, a titanium chelate is a material with excellent dielectric and conductive properties, but the titanium chelate itself has excellent conductive properties. Therefore, charges formed due to friction and external electric fields leak via the titanium chelate, which may cause a low charge of toners.

Although silicon oxide-titanium composite particles of silicon oxide and titania or a titanium alkoxide, or the like have existed conventionally, the present inventors have found, as a result of intensive studies, that excellent charge rising performance and environmental stability are exhibited by using a titanium chelate with excellent dielectric and conductive properties among titanium compounds and further chemically coupling a silicon polymer, which has excellent insulating properties, to the titanium chelate to cover the titanium chelate segments.

In a printer, a toner is charged by being rubbed against the triboelectric charge members, carriers, or the like with lower volume resistance than the toner. This charged toner is loaded on a developing roller in a single-component developing method and on a carrier in a double-component developing method. The loaded toner is transferred to the latent image section of a photoreceptor in a developing section due to the exterior electric field, forming an image.

As stated above, since a titanium chelate has high dielectric properties, the titanium chelate is polarized due to the external electric field in the developing section. In contrast, since the titanium chelate also has high conductive characteristics, polarized electric charges leak from a titanium chelate and further leak into a toner carrying member. To address such a problem, a silicon-titanium polymer composite in which silicon and a titanium chelate are chemically coupled is used in the present disclosure, thereby achieving a good charge rising performance. It is believed that the use of a silicon-titanium polymer composite in which silicon and a titanium chelate are chemically coupled exhibits the following two effects.

The first effect is that the silicon-titanium polymer composite has lower conductivity than a titanium chelate itself. This effect can suppress the leakage of charges to a toner carrying member. The second effect is that the electrostatic induction of the polarized charges of the titanium chelate segments to the silicon polymer segments by the bias during development provides charges also in a method other than triboelectric charging. As a result, it is believed that the silicon-titanium polymer composite can reach the saturation charge quantity more rapidly than a silicon polymer alone.

Furthermore, since it takes a long time for a toner to be charged and then developed in a printer with slow printing speed, the leakage of charges to a toner carrying member is likely to occur. Thus, by controlling the amount of titanium chelate near the surface of the silicon-titanium polymer composite, charge leakage to the toner carrying member is suppressed, thereby maintaining the charge rising performance.

It is noted that when, for example, a titanium alkoxide is used instead of a titanium chelate, the reactivity of the titanium alkoxide is high, and, therefore, titanium atoms are finely dispersed in the silicon-titanium polymer composite. As a result, the inside of the silicon-titanium polymer composite is more prone to conductive phenomena, and it is thus believed that fog is more likely to occur after long-term standing under high temperature and humidity environments.

Furthermore, since an electrostatic induction effect originating from the chelate segments cannot be exhibited when titanium oxide is used, sufficient conductivity cannot be achieved. Therefore, it is believed that the distribution of the charge quantity of a toner is broadened under low temperature and low humidity environments, and fog originating from the low charge quantity components is likely to occur.

Furthermore, by controlling the titanium amount on the surface of the silicon-titanium polymer composite, the environment stability is improved. Generally, titanium compounds used in toners, such as titania or a titanium chelate, are materials that easily adsorb moisture. Therefore, when the titanium amount derived from these materials on the toner surface is large, the influence of moisture adsorption of the toner is large. As a result, the silicon-titanium polymer composite adsorbs water and the conductive properties thereof increase by long-term standing in a high humidity environment, and the toner charge obtained due to friction and external electric fields is likely to leak to the toner carrying member by electrostatic induction, which reduces the charge quantity of the toner.

In response to this, the present inventors have examined the condition of the state of titanium in a silicon-titanium polymer composite from the viewpoint of good environmental stability and, as a result, made it clear that satisfying the following Formulas (1) and (2) is important.

$$1.0 \times 1 {0}^{- 3} \leq Ti - E \leq 2.5 \times 1 {0}^{- 2} \qquad ( 1 )$$

$$1. \times 1 {0}^{- 2} \leq Ti - E / Si - E \leq 7.0 \times 1 {0}^{- 2} . \qquad ( 2 )$$

The values of Ti-E and Si-E in Formulas (1) and (2) are obtained based on X-ray photoelectron spectroscopy analysis (ESCA) on a toner. Ti-E is the proportion of the number of atoms of titanium atoms in the sum of the atomic numbers of carbon atoms, oxygen atoms, silicon atoms, phosphorous atoms, and titanium atoms, and the proportion of the number of atoms of silicon atoms is Si-E.

In Formula (1), Ti-E represents the existence proportion of titanium elements near the surface. The lower the value of Ti-E, the smaller the amount of the titanium chelate segments near the surface. Since the overcharged charge cannot leak to the toner carrying member when Ti-E is less than 1.0×10⁻³, the toner is likely to charge up in low-humidity environments or the like, and image fog is likely to occur. When Ti-E exceeds 2.5×10⁻², the amount of the titanium chelate segments near the surface is large, and, therefore, electric charges are likely to leak into the toner carrying member, which decreases the charge quantity, particularly under a high temperature and high humidity environment and may cause image fog.

Ti-E is preferably 4.0×10⁻³ to 2.0×10⁻² and more preferably 5.0×10⁻³ to 1.5×10⁻².

In Formula (2), Ti-E/Si-E represents the proportion of titanium elements to silicon elements on the surface. A small Ti-E/Si-E represents that much of the surface is occupied by silicon polymer segments, and the charge site of the toner particle is strongly affected by the characteristics of the silicon polymer.

If Ti-E/Si-E is less than 1.0×10⁻², the charged site on the toner particle is strongly influenced by the insulator properties, which are properties of the silicon polymer, and, therefore, electric charges are likely to be accumulated on the toner, particularly under low-humidity environments, and image fog occurs. If Ti-E/Si-E exceeds 7.0×10⁻², the charged site on the surface of the toner particle is strongly influenced by the titanium chelate characteristics, for example, strongly influenced by moisture adsorption under high temperature and high humidity environments, and image fog occurs due to the decrease of toner charge quantity after long-term standing.

Ti-E/Si-E is preferably 2.0×10⁻² to 6.0×10⁻² and more preferably 2.5×10⁻² to 5.5×10⁻².

For satisfying Formulas (1) and (2), a method for controlling the dispersion state of titanium compounds may be mentioned. Generally, as reactive titanium compounds, titanium alkoxides and titanium acylates may be mentioned in addition to chelates. However, because titanium compounds such as alkoxides or acylates have higher reactivity than titanium chelate compounds, a titanium compound is finely dispersed in a silicon polymer when reacted with a silicon compound, which often causes percolation, or vice versa, aggregation of the titanium compound to increase the surface titanium amount.

Also, in view of the mild reactivity and easy controllability of reaction by pH or temperatures, it is preferred to use a titanium chelate in the present disclosure. The use of a titanium chelate is also preferred in view of the charge balance because chelate crosslinking exists in the silicon-titanium composite particle.

Hereinafter, more suitable embodiments of the present disclosure will be described.

The titanium chelate in the titanium chelate segment preferably contains at least one titanium chelate selected from the group consisting of a titanium phosphate chelate, titanium lactate, titanium lactate ammonium salt, titanium dodecylbenzenesulphonate, titanium acetylacetonate, titanium tetra(acetylacetonate), titanium ethylacetoacetate, and titanium octyleneglycolate.

The titanium chelate preferably contains at least one titanium chelate selected from the group consisting of titanium phosphate, titanium lactate, titanium lactate ammonium salt, and titanium dodecylbenzenesulphonate. In the silicon-titanium polymer composite, these titanium chelate compounds bind to the silicon polymer segment in a single-molecule, single-coordination manner and can efficiently form Ti—O—Si bonds with the chelate segment remaining, which is preferred from the viewpoint of the charge rising performance. The titanium chelate further preferably contains at least one titanium chelate selected from the group consisting of titanium lactate and titanium lactate ammonium salt. These titanium chelates may be used alone, or two or more types of these may be used together. In addition, inorganic fine particles with a low volume resistance, such as titania or alumina, may be used together.

From the viewpoint of the charge rising performance, as the titanium chelate content, the Ti element amount in the toner is preferably 1.000 to 5.000 mmol and more preferably 1.100 to 5.000 mmol in relation to 100 g of the toner base particle.

Furthermore, an analysis of the cross-section of the toner observed with a transmission electron microscope by energy dispersive X-ray spectroscopy (EDS) provides an EDS mapping image of the constitutional elements of a cross-section of the toner. In the EDS mapping image, when the proportion of the number of atoms of titanium atoms in the sum of the number of atoms of silicon atoms and titanium atoms in a region outside the outline of the toner base particle is taken as M-X (the number of atoms of titanium atoms/the number of atoms of silicon atoms and titanium atoms), M-X preferably satisfies Formula (3) below:

$$0.50 \times 1 {0}^{- 4} \leq M - X \leq 1.5 \times 1 {0}^{- 1} \qquad ( 3 )$$

M-X represents the detectable titanium chelate segments inside the silicon-titanium polymer composite, and the charge polarization caused by the titanium chelate segments can be facilitated when M-X is within the above range. Therefore, it is easier to maintain a high charge quantity throughout the durability test. Furthermore, M-X is more preferably 1.00×10⁻² to 8.00×10⁻² and further preferably 1.50×10⁻² to 5.00×10⁻².

M-X can be increased by increasing the amount of the Ti raw material added or by making the addition timing of the Si monomer to be reacted later or slowing down the condensation rate of the Si monomer. Furthermore, M-X can be reduced by making the addition timing the Si monomer earlier or speeding up the condensation rate of the Si monomer.

In a spectrum obtained by infrared spectroscopy of the silicon-titanium polymer composite, when the maximum value of a peak within a range of 900 cm⁻¹ to 1000 cm⁻¹ attributed to Ti—O—Si stretching vibration is taken as P_Ti, and the maximum of a peak within a range of 1000 cm⁻¹ to 1100 cm⁻¹ attributed to Si—O—Si stretching vibration is taken as P_Si, P_Ti and P_Si preferably satisfy Formula (4) below:

$$0.06 \leq P\_Ti / P\_Si \leq 0.15 \qquad ( 4 )$$

P_Ti/P_Si represents a proportion of chemically bonded Ti—O—Si, and when P_Ti/P_Si is within the above range, the polarization effect of charges originating from the titanium chelate segments can be increased regardless of printing speed, making image fog more easily suppressed. P_Ti/P_Si is more preferably 0.07 to 0.14.

P_Ti/P_Si can be increased by adjusting the timing of the Ti raw material added and pH in the initial stage of the reaction to conditions that facilitate the reaction to an active state. Furthermore, P_Ti/P_Si can be deceased by adjusting, in the initial stage of the reaction, the pH condition to be a condition that makes the Ti raw material less likely to react and increases the condensation rate of Si monomers.

In the toner, the silicon-titanium polymer composite is preferably adhered to the surface of the toner base particle in a protruded shape. Then, when the number average height of the protruded portion measured by a scanning probe microscope is taken as H, H is preferably 25 to 100 nm, more preferably 40 to 80 nm, and further preferably 50 to 70 nm. When His within the above range, changes in toner charge quantity and contamination of charge members can be better controlled. As a result, it is easier to control image density fluctuations and maintain high image quality in high-volume printers.

As means for adhering the silicon-titanium polymer composite to the surface of the toner base particle in a protruded shape, for example, the silicon-titanium polymer composite can be adhered to the surface of the toner base particle in a protruded shape, by adding the silicon-titanium polymer composite raw material and conducting a condensation reaction at the toner base particle interface while the toner base particle is dispersed in an aqueous medium.

The number average height H of the protruded portion can be increased by increasing the amount of Si monomer added or by slowing down the condensation rate and controlling the time for firm condensation. The average height H of the protruded portion can be reduced by using conditions with a high condensation rate, for example, under strong alkalinity, such as pH 10.

Furthermore, the silicon polymer segment in the silicon-titanium polymer composite preferably has a structure represented by the following Formula (5) (T3 unit structure). This further increases the dielectric characteristics of the toner particle, which can make it easier to maintain the charge quantity of the toner after high-volume printing on coarse paper.

R—SiO_{3/2} (5)

In Formula (5), R is a C1-6 (preferably C1-3, more preferably C1 or C2, and further preferably C1) alkyl group or a phenyl group.

Furthermore, it is also preferred that the silicon polymer segment has a structure represented by SiO_{4/2} (Q4 unit structure). For example, the silicon polymer segment has at least one selected from the group consisting of the structure represented by Formula (5) or a structure represented by SiO_{4/2}.

As the content of silicone polymer segments, the Si element amount in the toner is preferably 25.00 to 40.00 mmol and more preferably 30.00 to 36.00 mmol in relation to 100 g of the toner base particle.

The silicon-titanium polymer composite may be a fine particle of a silicon-titanium polymer composite as an external additive. For example, the toner may contain a toner base particle that contains a binder resin and a colorant and a fine particle of a silicon-titanium polymer composite. The silicon-titanium polymer composite also exhibits the effect described above when used as an external additive.

When silicon-titanium polymer composite is used as an external additive, the number-average particle diameter thereof is preferably from 25 nm to 100 nm and more preferably from 40 nm to 60 nm.

The measurement means of the number-average particle diameter is as follows.

Using a dynamic light scattering microtrac particle size distribution analyzer [UPA-150] (Nikkiso Co., Ltd.), the particle size distribution of the silicon-titanium polymer composite in an aqueous medium is calculated. The measurement is conducted while controlling the temperature of the cell so that the temperature of the aqueous medium used for the measurement and that of the measurement cell are the same. The particle size is measured at 25° C.
(1) Put 3.0 g of RO water in the cell and conduct Back ground check. Check for the sample loading be 0.0010 or less.
(2) Put 3.0 g of RO water in the cell and conduct Set Zero. Conduct Set Zero at a condition with a time of 60 seconds.
(3) Input the following conditions.

Measurement time: 30 seconds, the number of measurements: 2 times

Particle condition: transmissive, refractive index: 1.47, shape: non-spherical, density: 2.0

Solvent condition: select WATER

Refractive index: 1.47

Viscosity at high temperature: 0.797 (30° C.), viscosity at low temperature: 1.002 (20° C.)

Display setting: Select Standard

Distribution display: Select Volume
(4) Put 3.0 g of aqueous medium containing a silicon-titanium polymer composite in the measuring cell and start the measurement.
(5) Analyze the measurement data using the dedicated software provided with the device and calculate the number-average particle diameter (D1).

As the binder resin contained in the toner base particle, known one may be used without particular limitations. Examples thereof may include polystyrene; homopolymers of a styrene substituted product, such as poly-p-chlorostyrene and polyvinyl toluene; styrenic copolymers, such as a styrene-p-chlorostyrene copolymer, a styrene-vinyltoluene copolymer, a styrene-vinylnaphthalene copolymer, a styrene-acrylic ester copolymer, a styrene-methacrylic ester copolymer, a styrene-methyl α-chloromethacrylate copolymer, a styrene-acrylonitrile copolymer, a styrene-vinyl methyl ether copolymer, a styrene-vinyl ethyl ether copolymer, a styrene-methyl vinyl ketone copolymer, a styrene-butadiene copolymer, a styrene-isoprene copolymer, and a styrene-acrylonitrile indene copolymer; an acrylic resin; a methacrylic resin; polyvinyl acetate; a silicone resin; a polyester resin; a polyamide resin; a furan resin; an epoxy resin; a xylene resin; and the like. These resins may be used alone or in a mixture.

The binder resin preferably contains at least one selected from the group consisting of styrenic copolymers, which are copolymers of styrene and other vinyl monomers, and polyester resins and more preferably contains a styrenic copolymer. A polyester resin and/or a styrenic copolymer are/is preferred as the main components of the binder resin in view of developing performance and fixing performance. The main component refers to a component with a content ratio of 50% by mass or more. The binder resin further preferably contains a styrene-acrylic acid ester copolymer.

The monomer composition of the polyester resin is not particularly limited.

Examples of comonomers to a styrene monomer of the styrenic copolymer may include monocarboxylic acids having a double bond and substituted forms thereof, such as acrylic acid, methyl acrylate, ethyl acrylate, butyl acrylate, dodecyl acrylate, octyl acrylate, 2-ethylhexyl acrylate, phenyl acrylate, methacrylic acid, methyl methacrylate, ethyl methacrylate, butyl methacrylate, octyl methacrylate, acrylonitrile, methacrylonitrile, and acrylamide; dicarboxylic acids having a double bond and substituted forms thereof, such as maleic acid, butyl maleate, methyl maleate, and dimethyl maleate; vinyl esters such as vinyl chloride, vinyl acetate, and vinyl benzoate; ethylenic olefins such as ethylene, propylene, and butylene; vinyl ketones such as vinyl methyl ketone and vinyl hexyl ketone; and vinyl ethers such as vinyl methyl ether, vinyl ethyl ether, and vinyl isobutyl ether. These vinyl monomers may be used alone or in combination of two or more of these.

The styrenic copolymer described above is preferably crosslinked with a crosslinking agent in view of broadening the fixation temperature region of the toner and improving offset resistance. As the crosslinking agent, a compound having two or more polymerizable double bonds is used. Examples thereof may include aromatic divinyl compounds such as divinylbenzene and divinylnaphthalene; carboxylic acid esters with two double bonds such as ethylene glycol diacrylate, ethylene glycol dimethacrylate, and 1,3-butanediol dimethacrylate; divinyl compounds such as divinylaniline, divinyl ether, divinyl sulfide, and divinyl sulfone; and compounds with three or more vinyl groups. These may be used alone or as a mixture.

The toner base particle may contain a colorant. Examples of colorants may include known colorants such as various dyes and pigments that have been conventionally known.

Examples of coloring pigments for magenta may include C. I. Pigment Red 3, 5, 17, 22, 23, 38, 41, 112, 122, 123, 146, 149, 150, 178, 179, 190, and 202, and C. I. Pigment Violet 19 and 23. These pigments may be used alone, or dyes and pigments may be used together.

Examples of coloring pigments for cyan may include C. I. Pigment Blue 15, 15:1, and 15:3, or copper phthalocyanine pigments with one to five phthalimidomethyl groups substituted on the phthalocyanine backbone.

Examples of coloring pigments for yellow may include C. I. Pigment Yellow 1, 3, 12, 13, 14, 17, 55, 74, 83, 93, 94, 95, 97, 98, 109, 110, 154, 155, 166, 180, and 185.

As black colorants, carbon black, aniline black, acetylene black, titanium black, and materials color-matched to black with yellow/magenta/cyan colorants as listed above may be used.

The toner can be used as a magnetic toner, and in this case, magnetic bodies mentioned below are used. Iron oxides such as magnetite, maghemite, and ferrite, or iron oxides containing other metal oxides; metals such as Fe, Co, and Ni, or alloys of these metals with other metals such as Al, Co, Cu, Pb, Mg, Ni, Sn, Zn, Sb, Ca, Mn, Se, or Ti, and mixtures of these. More specifically, triiron tetroxide (Fe₃O₄), iron sesquioxide (γ-Fe₂O₃), zinc iron oxide (ZnFe₂O₄), copper iron oxide (CuFe₂O₄), neodymium iron oxide (NdFe₂O₃), barium iron oxide (BaFe₁₂O₁₉), magnesium iron oxide (MgFe₂O₄), and manganese iron oxide (MnFe₂O₄) may be mentioned. The magnetic bodies described above may be used alone or in combination of two or more of these. Particularly preferable magnetic bodies are fine powders of triiron tetroxide or γ-iron sesquioxide.

These magnetic bodies preferably have an average participle diameter from 0.1 μm to 2 μm and further probably have an average participle diameter from 0.1 μm to 0.3 μm. The magnetic properties at 795.8 kA/m (10 k oersted) application are: the coercive force (Hc) is from 1.6 kA/m to 12 kA/m (from 20 oersted to 150 oersted), the saturation magnetization (σs) is from 5 Am²/kg to 200 Am²/kg, and preferably from 50 Am²/kg to 100 Am²/kg. The residual magnetization (σr) is preferably from 2 Am²/kg to 20 Am²/kg.

The magnetic body is used in an amount from 10 to 200 parts by mass and more preferably from 20 to 150 parts by mass in relation to 100 parts by mass of the binder resin.

The toner base particle may contain a release agent. Examples of release agents may include aliphatic hydrocarbon waxes such as low molecular weight polyethylene, low molecular weight polypropylene, microcrystalline wax, and paraffin wax; oxides of aliphatic hydrocarbon waxes such as oxidized polyethylene wax; block copolymers of aliphatic hydrocarbon waxes; waxes mainly composed of fatty acid esters such as carnauba wax, sasol wax, and montanic acid ester wax; partially or fully deoxidized fatty acid esters such as deoxidized carnaba wax; partially esterified products of fatty acids and polyhydric alcohols such as behenic acid monoglycerides; and methyl ester compounds having a hydroxy group obtained by hydrogenating vegetable fats and oils.

As for the molecular weight distribution of the release agent, the main peak is preferably in the region of molecular weight from 400 to 2400 and more preferably in the region from 430 to 2000. This can impart favorable thermal characteristics to the toner. The amount of the release agent added is preferably from 2.5 to 40.0 parts by mass and more preferably from 3.0 to 15.0 parts by mass in relation to 100 parts by mass of the binder resin. These release agents may be used alone or in combination of two or more types thereof, and the use of a hydrocarbon wax and an ester wax is preferred in view of fixing performance.

The use of a charge control agent is a preferred form of a toner to maintain the charge performance stability of the toner. The following substances are used to control the toner to have a negative charge.

For example, organometallic compounds and chelate compounds are effective, and monoazo metal compounds, acetylacetone metal compounds, and metal compounds derived from aromatic oxycarboxylic acids, aromatic dicarboxylic acids, oxycarboxylic acids, and dicarboxylic acids may be mentioned. In addition, aromatic oxycarboxylic acids, aromatic mono and poly-carboxylic acids and metal salts, anhydrides, and esters thereof, phenol derivatives such as bisphenols, and the like may be mentioned.

Furthermore, urea derivatives, metal-containing salicylic acid compounds, metal-containing naphthoic acid compounds, boron compounds, quaternary ammonium salts, calixarenes, resin-based charge control agents, and the like may be mentioned.

The following substances are used to control the toner to have a positive charge.

Examples thereof may include nigrosine and modified nigrosine modified with a fatty acid metal salt or the like; guanidine compounds; imidazole compounds; quaternary ammonium salts such as tributylbenzylammonium-1-hydroxy-4-naphthosulfonic acid salts and tetrabutylammonium tetrafluoroborate; onium salts such as phosphonium salts, which are analogues of these salts, and lake pigments thereof; triphenylmethane dyes and lake pigments thereof (laking agents include phosphotungstic acid, phosphomolybdic acid, phosphotungsticmolybdic acid, tannic acid, lauric acid, gallic acid, ferricyanide, ferrocyanide and the like); metal salts of higher fatty acids; diorganotin oxides such as dibutyltin oxide, dioctyltin oxide, dicyclohexyltin oxide, and the like; diorganotinborates such as dibutyltinborate, dioctyltinborate, dicyclohexyltinborate; resin-based charge control agents; and the like. These may be used alone or in combination of two or more of these.

The toner may be used as a single-component and double-component developer in all development methods. For example, in the case of a magnetic toner containing a magnetic body in the toner as a single-component developer, a magnet built into the developing sleeve is used to transport and charge the magnetic toner. Furthermore, when a non-magnetic toner not containing a magnetic body is used, there is a method for attaching a toner on a developing roller by triboelectric charging using a blade or a fur brush.

If the toner is used as a double-component developer, for example, the magnetic carrier to be mixed with the toner is composed of elements selected from iron, copper, zinc, nickel, cobalt, manganese, chromium, and the like alone or in a composite ferrite state. The shape of the magnetic carrier used in this case can be spherical, flat, irregular, or the like. Furthermore, it is also possible to use a magnetic carrier, the surface microstructure (for example, surface unevenness) of which has been appropriately controlled. A resin-coated carrier with a surface coated with a resin can also be suitably used. The average particle diameter of the carrier used is preferably 10 to 100 μm and more preferably 20 to 50 μm. The toner concentration in the developer when a double-component developer is prepared by mixing these carriers and toners is preferably about 2 to 15% by mass.

The method for producing the toner is not particularly limited, and any known method may be used. It is preferred to produce a toner base particle in an aqueous medium and form a silicon-titanium polymer composite on the toner base particle surface. The methods for producing toner base particles are not particularly limited, and suspension polymerization methods, dissolution suspension methods, emulsion-coagulation methods, pulverization methods, and the like may be used. Among them, suspension polymerization methods are preferred.

First, a polymerizable monomer that can produce a binder resin and optional various additives are mixed, and a polymerizable monomer composition containing the materials dissolved or dispersed is prepared using a dispersing device. Polymerizable monomers can be those described above in the description of styrenic copolymers.

Various additives include colorants, release agents, plasticizers, charge control agents, polymerization initiators, and chain transfer agents.

Examples of dispersing devices may include homogenizers, ball mills, colloid mills, ultrasonic dispersing devices, or the like.

Next, a polymerizable monomer composition is fed in an aqueous medium containing hardly water-soluble inorganic fine particles, and droplets of the polymerizable monomer composition are prepared using a high-speed dispersing device, such as a high-speed stirrer or an ultrasonic dispersing device (granulating step).

After that, the polymerizable monomer in liquid droplets of the polymerizable monomer composition is polymerized to produce a toner base particle (polymerization step).

Next, a method for producing a silicon-titanium polymer composite will be described below by taking a case where a silane coupling agent is used as the organosilicon compound as an example.

As stated above, the titanium chelate itself has excellent dielectric and conductive properties, and the titanium chelate is a mildly reactive material, the reaction of which can be easily controlled by adjusting pH or temperature. Since the reaction properties of the titanium chelate and the silane coupling agent are different, it is possible to control the existing position of titanium by using the properties thereof.

First, in order to disperse a titanium chelate inside the composite, the two are mixed at a pH at which the titanium chelate is likely to react and the reaction of the silane coupling agent is inhibited. In this case, it is recommended that a coordinating polyhydric acid such as phosphoric acid be present in the system so that the titanium chelate can maintain the chelating state thereof and react easily.

After that, conditions are gradually adjusted to those wherein the silane coupling agent reacts more readily than the titanium chelate, for example, increasing the temperature or the pH. In this way, silicon-titanium polymer composites with controlled titanium existing state, i.e., Ti-E and Ti-E/Si-E, can be prepared.

In the preparation of the silicon-titanium polymer composite, pH adjustment may be performed from the following viewpoints.

From the viewpoint of minimizing the amount of titanium on the surface, the pH is preferably about 2.0 to 8.0, where the reactivity of silane coupling agents is low and the reactivity of titanium chelates is high and more preferably 3.0 to 6.0. Conversely, if the amount of titanium on the surface is to be slightly increased, the pH may be 8.5 to 10.5, the conditions under which silane coupling agents are likely to react.

If it is desired to incorporate other materials, a mixture of titanium chelate and a silane coupling agent may be added dropwise to the dispersion liquid in which the other materials are dispersed. A silicon-titanium polymer composite with a controlled titanium existing state may be prepared by appropriately adjusting the pH and temperature of the dispersion liquid during dropwise addition and further, the pH and temperature of the dispersion liquid after dropwise addition.

When a toner particle containing a toner base particle and a silicon-titanium polymer composite existing on the surface of the toner base particle is obtained, the following manufacturing method is preferred. The following production method can be used to deposit the silicon-titanium polymer composite on the surface of the toner base particle. Thus, for example, the silicon-titanium polymer composite may be adhered to the surface of the toner base particle in a planar manner.

First, a toner base particle dispersion liquid in which the toner base particles are dispersed in an aqueous diameter medium is obtained. For example, the dispersion liquid after the polymerization process described in the suspension polymerization method above may be used.

### Preparation of Silicon Compound Liquid

Meanwhile, it is preferred to hydrolyze silane coupling agents as silicon compounds in advance. Silane coupling agent and water are mixed and hydrolyzed at a pH suitable for hydrolysis to obtain a silicon compound liquid. The pH when hydrolysis is performed may be changed as appropriate depending on the type of silicon compounds. For example, the pH of the aqueous medium is preferably 2.0 to 6.0 and more preferably 4.0 to 6.0. The conditions for hydrolysis are preferably a temperature of 15° C. to 80° C. and a time of 30 to 600 minutes.

### First Step

The toner base particle dispersion liquid and the silicon compound liquid are mixed to obtain a mixture liquid. The amount of the silicon compound added is preferably within the range of the amount of Si elements (mmol) as described above in relation to 100 g of the toner base particle. As for the conditions in this case, it is preferred to adjust the pH to an appropriate level for hydrolysis, as with the preparation of the silicon compound liquid. For example, the pH of the mixture liquid is preferably 2.0 to 6.0 and more preferably 4.0 to 6.0. For example, the temperature is preferably 20 to 60° C. In the first step, the toner base particle dispersion liquid and the silicon compound liquid may be mixed, and the mixture liquid may be retained. The retention time is preferably 1 to 300 minutes and more preferably 1 to 120 minutes.

With respect to the pH in the first step, for example, when the titanium chelate is titanium lactate, the pH of the mixture liquid is preferably 3.0 or more and less than 5.5 and more preferably 3.5 or more and less than 5.2. If the pH of the mixture liquid is 5.5 or higher in the case where titanium lactate is added in the subsequent second step, the reaction activity of the titanium lactate is not sufficiently high, condensation of the silane coupling agent is prioritized, and Ti is hardly incorporated into the silicon-titanium polymer composite. Therefore, it is believed that even if titanium lactate reacts in further subsequent processes, Ti is likely to be present only on the surface of the silicon-titanium polymer composite.

In Japanese Patent Application Publication No. 2019-128515, the pH when titanium lactate is added is 5.5 or higher, which makes it difficult for the titanium lactate to react, and in the final acid treatment, the titanium lactate reacts with phosphate ions, and a large amount of Ti is deposited on the toner surface. Therefore, it is believed that Ti-E and Ti-E/Si-E exceed the upper limits of Formulas (1) and (2).

### Second Step

The mixture liquid obtained in the first step and a titanium chelate are mixed to form a silicon-titanium polymer composite on the surface of the toner base particle. The amount of the titanium chelate added is preferably within the range of the amount of Ti elements (mmol) as described above in relation to 100 g of the toner base particle. At this time, it is preferred to adjust the pH. From the viewpoint of minimizing the amount of titanium on the surface and reducing Ti-E and Ti-E/Si-E, the pH can be about 2.0 to 8.0, where the reactivity of silane coupling agents is low and that of titanium chelates is high. Conversely, if the amount of titanium on the surface is to be slightly increased and Ti-E and Ti-E/Si-E are to be increased, the pH may be 8.5 to 10.5, the conditions under which silane coupling agents are likely to react.

From the viewpoint of controlling Ti-E and Ti-E/Si-E, the pH in the second step is preferably 7.9 to 10.2.

From the pH of the mixture in the first step, the pH adjustment time when the pH is adjusted to the pH range mentioned above in the second step is preferably 1 to 90 minutes and more preferably 1 to 40 minutes. By changing the pH with the above adjustment time, the reactivity of the silane coupling agent is increased to facilitate the formation of particle shapes.

In the above explanation, the silicon compound liquid was added in the first step, and the titanium chelate was mixed in the second step, but this order may be reversed. That is, a mixture liquid obtained by mixing toner base particle dispersion liquid and titanium chelate may be obtained in the first step, and the mixture liquid and a silicon compound liquid may be mixed in the second step. By adopting such steps, the Ti—O—Si bond can be adjusted.

### Third Step

If necessary, a third step for retaining the pH and temperature, preferably for 1 to 5 hours, preferably at a pH of 8.5 to 10.5 and preferably at a temperature of 40° C. to 60° C., may be conducted subsequently to the second step. From the pH of the mixture in the second step, the pH adjustment time when the pH is adjusted to the above-mentioned pH range in the third step is preferably 1 to 90 minutes, more preferably 1 to 40 minutes. By adopting such a step, it is possible to adjust the distance between the silicon-titanium polymer composites on the surface of the toner base particles.

### Washing Step/Classification Step

After the second step (the third step if necessary), the toner particles may be washed and classified as necessary to obtain toner particles. For example, the pH during washing is 1.0 to 3.0. The resulting toner particle may be used as it is as a toner. The resulting toner particle may be made into a toner by adding an external additive.

The number-average particle diameter (D1) of the toner is preferably 4.0 to 12.0 μm and more preferably 5.0 to 8.0 μm. The weight-average particle diameter (D4) of the toner is preferably 4.0 to 12.0 μm and more preferably 6.0 to 9.0 μm.

In the first to third steps described above, Ti-E and Ti-E/Si-E may also be controlled by other means than pH adjustment.

For example, Ti-E can be increased by increasing the amount of Ti chelate added, by controlling the pH from the Ti chelate addition to the timing of silane coupling agent addition to a pH at which silane coupling agents are likely to react, or by lengthening the time of the acid-washing step. Ti-E/Si-E can be increased by increasing the amount of Ti chelate added or by lengthening the time of the acid-washing step, among others.

For example, Ti-E can be reduced by decreasing the amount of Ti chelate added or by making the timing of Ti chelate addition earlier. Furthermore, Ti-E/Si-E can also be reduced by prolonging the reaction under pH conditions where the Ti chelate is likely to react and silane coupling agents are less likely to react.

When fine particles of the silicon-titanium polymer composite are produced, the following methods are preferred. The silicon-titanium polymer composite is obtained as fine particles by the following method. By reacting a titanium chelate and a silicon compound liquid in the absence of the toner base particle, the titanium chelate and silicon compound liquid form oligomers, become hydrophobic, and precipitate in the aqueous medium, and further condensation reactions proceed, whereby fine particles can be obtained. When the toner base particle exists in an aqueous medium, the titanium chelate and silicon compound liquid are likely to gather around the resin of the toner base particle, and thus, a silicon-titanium polymer composite can be formed on the surface of the toner base particle. In this case, it is believed that the hydrophobic condensates are more likely to gather as the condensation progresses and form a protruded shape.

### Preparation of Silicon Compound Liquid

The silicon compound liquid may be prepared in the same manner as in the production of the toner particles described above.

### First Step

While stirring the aqueous medium, a titanium chelate and a silicon compound liquid are fed to allow the titanium chelate and the silicon compound to react with each other. The pH when the titanium chelate and the silicon compound liquid are fed is preferably 2.0 to 6.0 and more preferably 2.5 to 5.0. For example, the reaction time is 30 to 300 minutes.

Then, it is preferred to adjust the pH. That is, from the viewpoint of minimizing the amount of titanium on the surface and reducing Ti-E and Ti-E/Si-E, the pH can be about 2.0 to 8.0, where the reactivity of silane coupling agents is low and that of titanium chelates is high. Conversely, if the amount of titanium on the surface is to be slightly increased and Ti-E and Ti-E/Si-E are to be increased, that pH may be 8.5 to 10.5, the conditions under which silane coupling agents are likely to react. The pH adjustment time is preferably 1 to 90 minutes and more preferably 1 to 40 minutes.

From the viewpoint of controlling Ti-E and Ti-E/Si-E, the pH after the pH adjustment in the first step is preferably 7.9 to 10.2.

The amount of the titanium chelate added in relation to 100 parts by mass of silicon compounds is preferably 5 to 20 parts by mass and more preferably 11 to 17 parts by mass.

### Second Step

After that, from the viewpoint of facilitating the control of Ti-E and Ti-E/Si-E, a second step may be performed. In the second step, a titanium chelate and a silicon compound are further fed, and the resulting mixture is kept, preferably for 1 to 5 hours, preferably at a pH of 8.5 to 10.5 and preferably at a temperature of 40° C. to 60° C. In the second step, the amount of the titanium chelate added in relation to 100 parts by mass of silicon compounds is preferably 0.1 to 2.0 parts by mass and more preferably 0.1 to 0.5 parts by mass.

The silicon polymer segment in the silicon-titanium polymer composite is preferably a condensation polymerization product of an organosilicon compound and more preferably a condensation polymerization product of an organosilicon compound having a structure represented by the Formula (Y) below. That is, the silicon-titanium polymer composite is preferably a reaction product of a titanium chelate and an organosilicon compound having a structure represented by the Formula (Y).

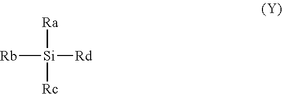

In Formula (Y),
Ra, Rb, Rc, and Rd each independently represent a halogen atom, a hydroxy group, an acetoxy group, or an alkoxy group (hereinafter, these are referred to as reaction groups), or
Ra represents a C1-6 (preferably C1-3, more preferably C1 or C2, and further preferably C1) alkyl group or phenyl group (as defined for R in Formula (5)), and Rb, Rc, and Rd each independently represent a halogen atom, a hydroxy group, an acetoxy group, or an alkoxy group.

Ra is preferably a C1-3 aliphatic hydrocarbon group and more preferably a methyl group.

A reactive group causes hydrolysis, addition polymerization, and condensation polymerization to form crosslinked structures. From the viewpoint of mild hydrolysis at room temperature and deposition properties on the surface of toner base particles, the reactive group is preferably a C1-3 alkoxy group and more preferably a methoxy group or an ethoxy group.

If Ra, Rb, Rc, and Rd are reactive groups, the compound of formula (Y) is preferably tetraethoxysilane.

If Ra is a C1-6 (preferably C1-3, more preferably C1 or C2, and further preferably C1) alkyl or phenyl group, and Ra, Rb, Rc, and Rd are reactive groups, i.e., trifunctional groups, the compound of formula (Y) is preferably compounds described below. Methyltrimethoxysilane is more preferred.

Trifunctional compounds represented by Formula (Y) include the following.

Trifunctional methylsilanes such as methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxy silane, and methyldiethoxyhydroxysilane.

Trifunctional silanes such as ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, and hexyltrihydroxysilane.

Trifunctional phenylsilanes such as phenyltrimethoxysilane, phenyltriethoxysilane, phenyltrichlorosilane, phenyltriacetoxysilane, and phenyltrihydroxysilane.

Next, the way of measuring various properties in the present disclosure will be described.

### Measurement of Ti-E and Si-E on Toner Surface

The ratio of the number of atoms including a silicon atom and the ratio of the number of atoms including the specific metal atoms, with respect to the sum of the number of atoms including a carbon atom, an oxygen atom, a silicon atom, a phosphorus atom, and a specific metal atom on the surface of the toner are calculated as follows.

Elemental analysis of the surface of the toner is performed using the following apparatus under the following conditions.
Measuring apparatus: Quantum 2000 (Trade name, and manufactured by ULVAC-PHI, INC)
X-ray source: monochrome Al Kα
Xray Setting: 100 μmφ (25 W (15 KV))
Photoelectron take-off angle: 45 degrees
Neutralization condition: combined use of neutralization gun and ion gun
Analysis area: 300×200 μm
Pass Energy: 58.70 eV
Step size: 1.25 eV
Analysis software: Maltipak (PHI)

Here, for the calculation of the number of atoms (atom %) including a silicon atom and a titanium metal atom, peaks of C 1c (B.E.280 to 295 eV), O 1s (B.E.525 to 540 eV), Si 2p (B.E.95 to 113 eV), P 2p (B.E.129 to 138 eV), and Ti 2p (B.E.456 to 470 eV) were used. The sum of the number of atoms including a carbon atom, an oxygen atom, a silicon atom, a phosphorus atom, and a titanium atom is calculated. With respect to the sum of numbers of these atoms, the ratio of the number of atoms including a silicon atom is defined as Si-E, and the ratio of the number of atoms including a titanium atom is defined as Ti-E.

That is, Si-E=(the number of atoms including silicon atom)/(Sum of the number of atoms including a carbon atom, an oxygen atom, a silicon atom, a phosphorus atom, and a titanium atom).

Also, Ti-E=(number of atoms including titanium atoms)/(Sum of the number of atoms including a carbon atom, an oxygen atom, a silicon atom, a phosphorus atom, and a titanium atom).

Ti-E/Si-E is calculated from the obtained Ti-E and Si-E.

### Measurement of M-X on Toner Cross-Section

First, the toner is spread as a single layer on the cover glass (Matsunami Glass Ind., Ltd., square cover glass No. 1), and an Os film (5 nm) and a naphthalene film (20 nm) are applied to the toner as a protective film using an osmium plasma coater (Filgen, Inc., OPC 80T). Next, a PTFE tube (inner diameter 1.5 mm×outer diameter 3 mm×3 mm) is filled with a photo-curing resin D800 (JEOL Ltd.), and the cover glass mentioned above is gently placed over the tube in such an orientation that the toner is in contact with the photo-curing resin D800.

After the resin is cured by being irradiated with light in this state, the cover glass and tube are removed to form a cylindrical resin with toner embedded on the outermost surface. The ultrasonic ultramicrotome (Leica Microsystems, UC7) is used to cut a cross-section of the toner from the outermost surface of the cylindrical resin at a cutting speed of 0.6 mm/s by a length of the toner radius (4.0 μm if the weight-average particle diameter (D4) is 8.0 μm). Next, the toner is cut into a film thickness of 100 nm to prepare a thinly sliced sample of toner cross-sections. By cutting the toner in this manner, a cross-section of the toner center can be obtained.

This thinly sliced sample was observed in the STEM mode of a scanning transmission electron microscope (JEOL Ltd., JEM 2800) connected to an EDS analyzer (energy dispersive X-ray analyzer) at a magnification of 400,000 times with a field of view where the outermost surface of the toner could be seen.

Spectra of the constituent elements of the observed toner cross-sections were collected using an EDS analyzer, and EDS mapping images were produced. The spectrum was collected and analyzed using NSS (Thermo Fisher Scientific Inc.). For the collection conditions, a probe size of 1.0 nm or 1.5 nm was selected as appropriate so that the acceleration voltage should be 200 kV, the dead time should be from 15 to 30, and 256×256 was taken as the mapping resolution, and 500 was taken as the number of frames. EDS mapping images were acquired for 30 cross-sections of the toner.

By analyzing the EDS mapping image thus obtained, the proportion of the number of atoms of titanium atoms in the sum of the number of atoms of silicon atoms and titanium atoms in the silicon-titanium polymer composite may be calculated.

First, press the “Extract from Line” button on the NSS and select the analysis area by freehand. Specifically, trace the interface between the toner base particle and the silicon polymer composite existing on the surface of the toner base particle and draw a baseline, then draw a parallel line parallel to the baseline 200 nm away from the baseline in the direction of the outline of the toner. The area sandwiched between the baseline and the parallel line is selected as the analysis range, which is the area outside the contour of the toner base particle.

Once the analysis range of the toner is selected, press the “Quantify Spectrum” button to automatically calculate the percentage (atomic %) of silicon and titanium atoms in the selected range. At this time, select silicon and titanium as the elements to be analyzed. On the basis of the values of the proportion of the silicon atom (atomic %) and the proportion of titanium atoms (atomic %) displayed in the quantitative results, the proportion M-X of the number of atoms of titanium atoms in the sum of the number of atoms of silicon atoms and titanium atoms in the silicon-titanium polymer composite may be calculated.

That is, M−X=(the number of atoms titanium atoms)/(the sum of the number of atoms of silicon atoms and titanium atoms). Adopt an arithmetic average value of 30 cross-sections of the toner.

### Infrared Spectroscopy of Silicon-Titanium Polymer Composite

In measuring the silicon-titanium polymer composite, the sample is prepared by performing the following process in advance to isolate the silicon-titanium polymer composite. The following description is based on the case where the sample is a toner, but the same procedure may be used to isolate other samples.

Case where Fine Particles of Silicon-Titanium Polymer Composite are Added as External Additive

A Case where fine particles of the silicon-titanium polymer composite are added as an external additive Toner particles and silicon-titanium polymer composite fine particles (external additive) are collected from the toner by the following method. Add 160 g of sucrose (made by Kishida Chemical Co., Ltd.) to 100 mL of ion exchange water, and dissolve the sucrose while being warmed with hot water to prepare a sucrose concentrate liquid. Put 31 g of the sucrose concentrate and 6 mL of Contaminon N in a centrifuge tube to prepare a dispersion liquid. Add 1 g of a toner to this dispersion liquid, and loosen aggregates of the toner with a spatula or a similar tool.

Shake a centrifuge tube for 20 minutes at 350 reciprocations per minute with a KM Shaker (model: V.SX) manufactured by Iwaki Sangyo Co., Ltd. After shaking, replace the solution in a glass tube for a swing rotor (50 mL), and centrifuge the solution in a centrifuge at 3500 rpm for 30 minutes. Since toner particles exist in the outermost layer and fine particles of the silicon-titanium polymer composite (external additive) exist on the aqueous solution side of the lower layer in the glass tube after centrifugation, separate these. If necessary, shaking and centrifugation may be repeated for sufficient separation. By repeating these operations, collect the required amount of toner particles or external additives.

Case where Toner Particle Contains Toner Base Particle and Silicon-Titanium Polymer Composite Existing on Surface of Toner Base Particle

If the toner particle contains a toner base particle and a silicon-titanium polymer composite existing on the surface of the toner base particle, the silicon-titanium polymer composite is collected in the following manner. If any external additive to be removed is present, the toner particles may be obtained with the external additive removed by the procedure mentioned above.

The way of collecting the silicon-titanium polymer composite from the toner particle will be described. First, weigh 10.0 g of toner particles and mix the toner particles with 100 mL of N,N-dimethylformamide (DMF) for 60 minutes under stirring. The mixture may be heated up to 80° C. during stirring and mixing if necessary. After stirring for 60 minutes, replace the mixture liquid brought to room temperature in a glass tube for a swing rotor (50 mL), and centrifuge the mixture liquid in a centrifuge at 3500 rpm for 30 minutes. In the glass tube after centrifugation, the DMF insoluble matter containing silicon-titanium polymer composite exists in the lower layer. Collect this insoluble matter. Repeat this operation three times. After that, disperse the collected insoluble matter in 100 mL of RO water and centrifuge the resulting dispersion at a condition of 3500 rpm and 30 minutes. At this time, the insoluble matter in the lower layer of the glass tube collected and dried is taken as the silicon-titanium polymer composite.

### Infrared Spectroscopy

Using the fine particles of the silicon-titanium polymer composite obtained in the above procedure or a silicon-titanium polymer composite as a sample, analysis is conducted according to the following procedure.

FT-IR analysis is conducted using a Fourier transform infrared spectrometer (Frontier: manufactured by PerkinElmer Inc., software: Spectrum 10) equipped with the Universal ATR Sampling Accessory, and the measurement is conducted using an ATR method. Specific measurement procedures and the way of calculating P_Ti/P_Si are as follows. Set the angle of incidence of the infrared light (λ=5 μm) to 45°. As the ATR crystals, use Ge ATR crystals (refractive index: 4.0). The other conditions are as follows. The measurement range when Ge is used as an ATR crystal is about 200 nm from the sample surface.

### Range

Start: 4000 cm⁻¹

End: 650 cm⁻¹ (ATR crystal of Ge)

### Duration

Scan number: 16

Resolution: 4.00 cm⁻¹

Advanced: with CO₂/H₂O correction

### Calculation of P_Ti/P_Si

(1) Mount a Ge ATR crystal on a device.
(2) Set Scan type to Background and Units to EGY and measure the background.
(3) Set Scan type to Sample and Units to A.
(4) Weigh 0.01 g of the sample on the ATR crystal exactly.
(5) Pressurize the sample with a pressure arm. (Force Gauge is 45)
(6) Measure the sample.
(7) Perform baseline correction of the obtained FT-IR spectrum by Automatic Correction.
(8) Check for the existence of any peak near 926 cm⁻¹. This absorption peak is derived from the stretching vibration of Ti—O—Si bonds. Then, calculate this peak value (the calculated value is taken as T1).
(9) Calculate the average of the absorption intensities at 900 cm⁻¹ and 1000 cm⁻¹ (the calculated value is taken as T2)
(10) Take T1-T2=P_Ti. Define P_Ti as the maximum absorption peak intensity corresponding to the stretching vibration of Ti—O—Si.
(11) Calculate the maximum value of the absorption intensities at 1000 cm⁻¹ and 1100 cm⁻¹ (the calculated value is taken as S1)
(12) Calculate the average of the absorption intensities at 1000 cm⁻¹ and 1100 cm⁻¹ (the calculated value is taken as S2)
(13) Take S1-S2=P_Si. Define P_Si as the maximum absorption peak intensity within the range of 1000 cm⁻¹ and 1100 cm⁻¹ or lower corresponding to the stretching vibration of Si—O—Si.
(14) Using the P_Ti and P_Si determined as above, calculate P_Ti/P_Si by dividing P_Ti by P_Si.

### Measurement of Average Height H of Protruded Portion on Surface of Toner Particle

The protruded portion on the surface of the toner particle is observed in the following manner.

Using “AFM 5500M”, a scanning probe microscope (SPM) manufactured by Hitachi High-Tech Corporation, derive the force curve by measuring the protruded portion on the surface of the toner particle and the surface layer of the toner core particle. The cantilever (hereinafter also referred to as “probe”) used for the measurement is the “SI-DF3P2” sold by Hitachi High-Tech Fielding Corporation.

Calibrate the SPM used in the measurement for positional accuracy in the XYZ direction in advance, and measure the tip radius of curvature of the probe tip of the cantilever used in the measurement in advance.

Any method of measuring the radius of curvature of the probe tip can be used, but, for example, the probe evaluation example “TGT1-NT-MDT” sold by Hitachi High-Tech Fielding Corporation can be used for the measurement. The value of the radius of curvature of the tip can be any value that allows measurement of the toner particle surface layer without touching the protruded portion, but from the viewpoint of ensuring resolution, the value is preferably 20 nm or less. In the present disclosure, the value was 10 nm.

Using SI-DF3P2 as a cantilever the measurement, the measurement is conducted in a dynamic force mode. In the measurement of toner particles, attach a conductive double-sided tape to the sample stand first, and spray toner particles thereonto. Then, air blow the sample stand to remove excess toner particles. Measure the shape of this sample in the 1 μm×1 μm area on the toner particle surface with AFM 5500M to observe the protruded portion on the toner particle surface. The toner particle with an equal particle diameter to the weight-average particle diameter (D4) was selected as the measurement target of the toner particle.

After measurement, correct the inclination of the measurement data in a 1 μm×1 μm area and calculate the maximum surface height Sp. Sp means a maximum height from the outermost surface to the apex of the protruded portion of the toner particle in a 1 μm×1 μm area. Determine Maximum heights h1 to h50 of the apex of the protruded portion of 50 toner particles by the method mentioned above, and take the arithmetic average of h1 to h50 as the average height H (nm) of the protruded portion.

### Measurement of Particle Diameter of Toner Particle

The particle diameter of the toner particle may be measured by a pore electrical resistance method. For example, the particle diameter can be measured and calculated using “Coulter Counter Multisizer 3” and the accompanying dedicated software “Beckman Coulter Multisizer 3 Version 3.51” (manufactured by Beckman Coulter Inc.).

A precision particle size distribution analyzer using the pore electrical resistance method (product name: Coulter Counter Multisizer 3) and dedicated software (product name: Beckman Coulter Multisizer 3 Version 3.51, manufactured by Beckman Coulter Inc.) are used. Measurement is performed at an aperture diameter of 100 μm, the number of effective measurement channels of 25,000, and the measurement data is analyzed and calculated.

The aqueous electrolytic solution used for the measurement may be a solution in which guaranteed grade sodium chloride is dissolved in ion exchange water so that the concentration is about 1% by mass, for example, ISOTON II (trade name) manufactured by Beckman Coulter.

Before measurement and analysis, set up the dedicated software mentioned above as follows.

In the “Change Standard Measurement Method (SOM) screen” of the dedicated software mentioned above, set the total number of counts in the control mode to 50,000 particles, the number of measurements to one, and the Kd value to the value obtained using (standard particles 10.0 μm, manufactured by Beckman Coulter). Press the Threshold/Noise Level measurement button to set the threshold and noise level automatically. Also, set the current to 1600 μA, the gain to 2, the electrolyte to ISOTON II (trade name), and check the aperture tube flush after measurement.

In the “Pulse to Grain Size Conversion Settings Screen” of the dedicated software, set the bin interval to logarithmic grain size, the grain size bin to 256 grain size bins, and the grain size range to a range from 2 μm to 60 μm.

The specific way of measurement is as follows.
(1) Put about 200 mL of the aqueous electrolytic solution mentioned above in a 250-mL round-bottomed glass beaker dedicated to Multisizer 3, set the beaker on a sample stand, and stir the stirrer rod counterclockwise at 24 revolutions per second. Then, remove dirt and air bubbles in the aperture tube using the “Flush Aperture Tube” function of the dedicated software.
(2) Put about 30 mL of the aqueous electrolytic solution in a 100-mL flat-bottomed glass beaker. Add 0.3 mL of a diluted solution obtained by diluting Contaminon N (trade name) (10% by mass aqueous solution of neutral detergent for cleaning precision measuring instruments, manufactured by Wako Pure Chemical Industries, Ltd.) by 3 mass times with ion exchange water.
(3) Install two oscillators with an oscillation frequency of 50 kHz, with the phase shifted by 180 degrees, and add a predetermined amount of ion exchange water and 2 mL of Contaminon N (trade name) in a water tank of an ultrasonic dispersion unit with an electrical output of 120 W (product name: Ultrasonic Dispersion System Tetora 150, manufactured by Nikkaki Bios Co. Ltd.).
(4) Set the beaker described in (2) above in the beaker fixing hole of the ultrasonic dispersion system and activate the ultrasonic dispersion system. Then, adjust the height position of the beaker so that the resonance state of the liquid surface of the aqueous electrolytic solution in the beaker is maximized.
(5) Add and disperse 10 mg of toner (particles) to the aqueous electrolytic solution in small quantities in a state where the aqueous electrolytic solution in the beaker described in (4) above is irradiated with ultrasonic waves. Then, continue the ultrasonic dispersion process for another 60 seconds. For ultrasonic dispersion, adjust the water temperature in the tank to a temperature from 10° C. to 40° C.
(6) Add dropwise the aqueous electrolytic solution described in (5) above containing dispersed toner (particles) to the round-bottomed beaker described in (1) above, placed in the sample stand, with a pipette to adjust the measurement concentration be 5%. Then, continue the measurement until the number of particles measured reaches 50000.
(7) Analyze the measurement data using the above-mentioned dedicated software equipped with the device and calculate the weight-average particle diameter (D4). The “average diameter” on the Analysis/Volume Statistics (Arithmetic Average) screen when graph/volume % is set in the dedicated software is the weight-average particle diameter (D4). The “average diameter” on the Analysis/Volume Statistics (Arithmetic Average) screen when graph/number % is set in the dedicated software is the weight-average particle diameter (D1).

As the measurement sample, a pellet of about 2 mm in thickness and 39 mm in diameter, obtained by placing about 4 g of a toner in a special aluminum ring for pressing, then flattening the toner, and pressurizing the toner for 60 seconds at 20 MPa using a tablet compacting machine, BRE-32 (manufactured by Maekawa Testing Machine MFG. Co., Ltd.), is used.

Perform the measurement under the above conditions, identify the element based on the X-ray peak position obtained, and calculate the concentration from the counting rate (unit: cps), which is the number of X-ray photons per unit time.

### Quantification Method of Amount of Ti Elements and Si Elements in Toner

The following is an example for silicon. In the case of titanium, the concentration can be determined by changing SiO₂ to TiO₂.

Add 0.05 parts by mass of silica (SiO₂) fine powder of 10 nm or smaller in relation to 100 parts by mass of particles having a similar composition, except that silicon or titanium elements are not contained, and a similar particle diameter to those of toner particles, and mix thoroughly using a coffee mill. Similarly, mix 0.25 and 0.50 parts by mass, respectively, of 10 nm silica fine powder with toner particles, and these are used as samples for calibration curves.

For each sample, prepare a pellet of the sample for calibration curve as described above using a tablet compacting machine, and measure the counting rate (unit: cps) of the Si-Kα line observed at the diffraction angle (20)=109.08° when PET is used as the spectral crystal. In this case, set the accelerating voltage and current of the X-ray generator to 24 kV and 100 mA, respectively. Acquire a linear function calibration curve with the obtained X-ray counting rate on the vertical axis and the amount of SiO₂ added in each sample for the calibration curve on the horizontal axis.

Next, mold toner particles to be analyzed into pellets in the manner as described above using a tablet compacting machine, and measure the Si-Kα ray counting rates. Then, from the above calibration curve, calculate the amount of Si (mmol) in the toner in relation to 100 g of the toner base particle in terms of SiO₂.

### EXAMPLES

Hereinafter, the present invention will be described in more detail with reference to Examples. The present invention is not limited to the Examples below. All parts and percentages in the formulations of the Examples and Comparative Examples are on a mass basis unless otherwise noted.

### Toner Production Example 1

### Preparation Example of Toner Base Particle Dispersion Liquid 1

11.2 parts of sodium phosphate (dodecahydrate) was added to a reaction vessel containing 350.0 parts of ion-exchanged water, and this was kept at 65° C. for 1.0 hours while being purged with nitrogen. Using T.K. Homomixer (manufactured by Tokushu Kika Kogyo Co., Ltd), a calcium chloride aqueous solution in which 7.4 parts of calcium chloride (dihydrate) was dissolved in 10.0 parts of ion-exchanged water was collectively charged into a reaction vessel with stirring at 12,000 rpm to prepare an aqueous medium containing a dispersion stabilizer.

Furthermore, 1.0 mol/L hydrochloric acid was added to the aqueous medium in the reaction vessel to adjust the pH to 5.0, thereby preparing an aqueous medium 1.

### Preparation of Polymerizable Monomer Composition

| | |
|---|---|
| Styrene | 60.0 parts |
| C. I. Pigment Blue 15:3 | 6.3 parts |

The above materials were put into an attritor (manufactured by NIPPON COKE & ENGINEERING CO., LTD), and further dispersed at 220 rpm for 5.0 hours using zirconia particles having a diameter of 1.7 mm to prepare a colorant-dispersed solution in which a pigment was dispersed.

Next, the following materials were added to the colorant dispersion liquid.

| Styrene | 12.0 parts |
|---|---|
| n-Butyl acrylate | 28.0 parts |
| Polyester resin | 5.0 parts |
| (Condensation polymerization product of terephthalic | |
| acid and propylene oxide 2-mole adduct of | |
| bisphenol A; weight-average molecular weight | |
| Mw = 10,000; acid value: 8.2 mg KOH/g) | |
| HNP51 (melting point: 76° C., manufactured | 6.0 parts |
| by Nippon Seiro Co., Ltd.) | |

The above materials were kept at 65° C., and uniformly dissolved and dispersed at 500 rpm using T.K. Homomixer to prepare a polymerizable monomer composition.

### Granulating Step

While the temperature of the aqueous medium 1 was maintained at 70° C. and the rotation speed of a stirring device was maintained at 12,000 rpm, the polymerizable monomer composition was charged into the aqueous medium 1, and 8.0 parts of t-butyl peroxypivalate as a polymerization initiator was added thereto. Granulation was performed for 5 minutes while maintaining 12,000 rpm with a stirrer as it was.

### Polymerization Step

The polymerization reaction was carried out by changing a high-speed stirrer to a stirrer equipped with propeller stirring blades, maintaining the temperature at 70° C. while stirring at 200 rpm for 5.0 hours, and then raising the temperature to 85° C. and heating the reaction mixture for 2.0 hours. The temperature was further raised to 98° C. and heated for 3.0 hours to remove residual monomer, and the concentration of the toner base particle in the dispersion liquid was adjusted to 30.0% by mass and pH to 5.0 by adding a 1-mol/L aqueous HCl or NaOH solution and ion exchange water to obtain a toner base particle dispersion liquid 1 containing a toner base particle 1 dispersed therein.

The number-average particle diameter (D1) of the toner base particle 1 was 6.2 μm, and the weight-average particle diameter (D4) was 6.9 μm.

### Preparation Example of Toner Base Particle Dispersion Liquid 2

In the same manner as the toner base particle dispersion liquid 1, a toner base particle dispersion 2 containing a toner base particle 2 dispersed therein, adjusted to have a toner base particle concentration of 30.0% by mass and a pH of 4.0, was obtained. The number-average particle diameter (D1) of the toner base particle 2 was 6.2 μm, and the weight-average particle diameter (D4) was 6.9 μm.

### Preparation Example of Toner Base Particle Dispersion Liquid 3

In the same manner as the toner base particle dispersion liquid 1, a toner base particle dispersion liquid 3 in which a toner base particle 3 adjusted to have a toner base particle concentration of 30.0% by mass and a pH of 3.5. The number-average particle diameter (D1) of the toner base particle 3 was 6.2 μm, and the weight-average particle diameter (D4) was 6.9 μm.

### Preparation Example of Silicon Compound Liquid 1

| | |
|---|---|
| Ion exchange water | 50.0 parts |
| Methyltrimethoxysilane | 50.0 parts |

The above materials were weighed in a 200-mL beaker, and the pH was adjusted to 5.0 with 10% hydrochloric acid. After that, the mixture was stirred for 2.0 hours while heated to 30° C. in a water bath to prepare a silicon compound liquid 1.

### Production Example of Silicon Compound Liquid 2

A silicon compound liquid 2 was prepared in the same manner as the silicon compound liquid 1, except that methyltrimethoxysilane (MTMS) in the silicon compound liquid 1 was changed to tetraethoxysilane (TEOS).

### Production Example of Toner 1

### First Step

| | |
|---|---|
| Toner base particle dispersion Liquid 1 | 300.00 parts |
| Silicon compound liquid 1 | 9.68 parts |

The above samples were weighed in a reaction vessel and mixed using a propeller stirring blade. Next, the pH of the resulting mixture liquid was adjusted to 5.0 using a 1-mol/L aqueous HCl or NaOH solution, and the temperature of the mixture liquid was kept at 50° C. for 30 minutes while mixing using a propeller stirring blade.

### Second Step

| | |
|---|---|
| 44% Aqueous titanium lactate solution | 1.05 parts |
| (TC-315: manufactured by Matsumoto Fine | |
| Chemical Co., Ltd.) | |

Subsequently, the above samples were then weighed and mixed in the reaction vessel, and the pH of the resulting mixture liquid was adjusted to 9.0 using a 1-mol/L aqueous NaOH solution over 30 minutes and kept for 5.0 hours.

### Washing to Classification Steps

Next, the temperature was lowered to 25° C., the pH was adjusted to 1.5 with a 1-mol/L hydrochloric acid, the mixture was stirred for 15 minutes, and then filtered while washing with ion exchange water to obtain toner particle 1 with protruded portions of silicon-titanium composite. Tables 1-1 and 1-2 show the production conditions of the like of the toner particle 1. The obtained toner particle 1 was used as it is as a toner 1. Table 2 shows the properties of the obtained toner 1.

### Production Example of Toner 2

### First Step

| | |
|---|---|
| Toner base particle dispersion liquid 1 | 300.00 parts |
| Silicon compound liquid 1 | 7.09 parts |

The samples mentioned above were weighed in a reaction vessel and mixed using a propeller stirring blade. Next, the pH of the resulting mixture liquid was adjusted to 5.0 using a 1-mol/L aqueous HCl or NaOH solution, and the temperature of the mixture liquid was raised to 50° C. and kept at the same temperature for 30 minutes while mixing using a propeller stirring blade.

### Second Step

| | |
|---|---|
| 44% Aqueous titanium lactate solution | 0.58 parts |
| (TC-315: manufactured by Matsumoto Fine | |
| Chemical Co., Ltd.) | |

Subsequently, the sample mentioned above was weighed and mixed in the reaction vessel, and the pH of the resulting mixture liquid was adjusted to 8.0 using a 1-mol/L aqueous NaOH solution over 30 minutes and kept for 1.0 hours.

### Third Step

Regarding the sample after the second step, the pH of the resulting mixture liquid was adjusted to 10.0 using a 1-mol/L aqueous NaOH solution over 30 minutes and held for 4.0 hours.

### Washing to Classification Steps

Next, the temperature was lowered to 25° C., then the pH was adjusted to 1.5 with a 1-mol/L hydrochloric acid, the mixture was stirred for 15 minutes, and then filtered while washing with ion exchange water to obtain toner particle 2 with protruded portions of silicon-titanium composite. Tables 1-1 and 1-2 show the production conditions of the like of the toner particle 2. The obtained toner particle 2 was used as it is as a toner 2. Table 2 shows the properties of the obtained toner 2.

### Production Examples of Toners 3, 4, 14, 16, 20, 22, and 25

Toners 3, 4, 14, 16, 20, 22, and 25 were obtained in the same manner as the production method of the toner 2, except that the materials and conditions of the toner 2 indicated in the production example of the toner 2 were changed to those listed in tables 1-1 and 1-2. Table 2 shows the properties of the obtained toner.

### Production Examples of Toners 5 to 13, 15, 17 to 19, 21, 23, 24, and 26

Toners 5 to 13, 15, 17 to 19, 21, 23, 24, and 26 were obtained in the same manner as the production method of the toner 1, except that the materials and conditions of the toner 1 indicated in the production example of the toner 1 were changed to those listed in tables 1-1 and 1-2. Table 2 shows the properties of the obtained toner.

### Production Example of Toner 27

### First Step

In the reaction vessel, 300 parts of the toner base particle dispersion liquid 1 and 0.01 parts of sodium chloride were fed, and the pH was adjusted to 9.0 using a 1-mol/L aqueous NaOH solution while stirring at 10,000 rpm using CLEARMIX. Next, 0.045 parts of titanium oxide with a number average particle diameter of 25 nm was fed and stirred at 50° C. for 10 minutes.

### Second Step

The stirrer in the reaction vessel was changed from CLEARMIX to a propeller stirring blade. After that, the following samples were weighed and dropped into the reaction vessel over 30 minutes.

| | |
|---|---|
| Silicon compound liquid 1 | 9.69 parts |

The resulting mixture was stirred at 50° C. for 5 hours.

### Washing to Classification Steps

Next, the temperature was lowered to 25° C., then the pH was adjusted to 1.5 with 1 mol/L hydrochloric acid, the mixture was stirred for 15 minutes, and then filtered while washing with ion exchange water to obtain toner particle 27 with protruded portions of silicon-titanium composite. The toner particle 27 was used to form a toner 27. Table 2 shows the properties of the obtained toner 27.

TABLE 1-1

| | First step | | | | | | |
|---|---|---|---|---|---|---|---|
| | | Amount of | | Amount of | | | |
| Toner | | base particle | | additive | | Temp- | Step time |
| No. | Base particle | added | Additive | [parts] | pH | erature | [minutes] |
| 1 | Toner base particle | 300 parts | Silicon | 9.68 | 5.0 | 50° C. | 30 |
| | dispersion liquid 1 | | compound | | | | |
| | | | liquid 1 | | | | |
| 2 | Toner base particle | 300 parts | Silicon | 7.09 | 5.0 | 50° C. | 30 |
| | dispersion liquid 1 | | compound | | | | |
| | | | liquid 1 | | | | |
| 3 | Toner base particle | 300 parts | Silicon | 8.02 | 4.0 | 45° C. | 60 |
| | dispersion liquid 2 | | compound | | | | |
| | | | liquid 1 | | | | |
| 4 | Toner base particle | 300 parts | TC-315 | 0.58 | 4.0 | 50° C. | 30 |
| | dispersion liquid 2 | | | | | | |
| 5 | Toner base particle | 300 parts | Silicon | 9.69 | 5.0 | 50° C. | 1 |
| | dispersion liquid 1 | | compound | | | | |
| | | | liquid 1 | | | | |
| 6 | Toner base particle | 300 parts | Silicon | 10.56 | 4.0 | 60° C. | 1 |
| | dispersion liquid 2 | | compound | | | | |
| | | | liquid 1 | | | | |
| 7 | Toner base particle | 300 parts | Silicon | 10.17 | 5.0 | 40° C. | 30 |
| | dispersion liquid 1 | | compound | | | | |
| | | | liquid 1 | | | | |
| 8 | Toner base particle | 300 parts | Silicon | 9.69 | 5.0 | 50° C. | 30 |
| | dispersion liquid 1 | | compound | | | | |
| | | | liquid 1 | | | | |
| 9 | Toner base particle | 300 parts | Silicon | 10.17 | 5.0 | 35° C. | 30 |
| | dispersion liquid 1 | | compound | | | | |
| | | | liquid 1 | | | | |
| 10 | Toner base particle | 300 parts | Silicon | 9.68 | 5.0 | 50° C. | 30 |
| | dispersion liquid 1 | | compound | | | | |
| | | | liquid 1 | | | | |
| 11 | Toner base particle | 300 parts | Silicon | 9.68 | 5.0 | 50° C. | 30 |
| | dispersion liquid 1 | | compound | | | | |
| | | | liquid 2 | | | | |
| 12 | Toner base particle | 300 parts | Silicon | 10.00 | 5.0 | 45° C. | 30 |
| | dispersion liquid 1 | | compound | | | | |
| | | | liquid 1 | | | | |
| 13 | Toner base particle | 300 parts | Silicon | 10.00 | 5.0 | 45° C. | 30 |
| | dispersion liquid 1 | | compound | | | | |
| | | | liquid 1 | | | | |
| 14 | Toner base particle | 300 parts | TC-315 | 0.73 | 4.0 | 50° C. | 30 |
| | dispersion liquid 2 | | | | | | |
| 15 | Toner base particle | 300 parts | Silicon | 11.91 | 5.0 | 60° C. | 30 |
| | dispersion liquid 1 | | compound | | | | |
| | | | liquid 1 | | | | |
| 16 | Toner base particle | 300 parts | Silicon | 8.23 | 4.0 | 45° C. | 30 |
| | dispersion liquid 2 | | compound | | | | |
| | | | liquid 1 | | | | |
| 17 | Toner base particle | 300 parts | Silicon | 8.23 | 5.0 | 30° C. | 30 |
| | dispersion liquid 1 | | compound | | | | |
| | | | liquid 1 | | | | |
| 18 | Toner base particle | 300 parts | Silicon | 10.17 | 5.0 | 35° C. | 1 |
| | dispersion liquid 1 | | compound | | | | |
| | | | liquid 1 | | | | |
| 19 | Toner base particle | 300 parts | Silicon | 9.19 | 4.5 | 40° C. | 1 |
| | dispersion liquid 2 | | compound | | | | |
| | | | liquid 1 | | | | |
| 20 | Toner base particle | 300 parts | Silicon | 6.49 | 5.0 | 50° C. | 30 |
| | dispersion liquid 1 | | compound | | | | |
| | | | liquid 1 | | | | |
| 21 | Toner base particle | 300 parts | Silicon | 9.68 | 5.0 | 50° C. | 30 |
| | dispersion liquid 1 | | compound | | | | |
| | | | liquid 1 | | | | |
| 22 | Toner base particle | 300 parts | Silicon | 8.31 | 5.0 | 50° C. | 30 |
| | dispersion liquid 1 | | compound | | | | |
| | | | liquid 1 | | | | |
| 23 | Toner base particle | 300 parts | Silicon | 10.00 | 5.0 | 45° C. | 30 |
| | dispersion liquid 1 | | compound | | | | |
| | | | liquid 1 | | | | |
| 24 | Toner base particle | 300 parts | Silicon | 9.69 | 5.0 | 50° C. | 30 |
| | dispersion liquid 1 | | compound | | | | |
| | | | liquid 1 | | | | |
| 25 | Toner base particle | 300 parts | Silicon | 9.69 | 4.0 | 55° C. | 1 |
| | dispersion liquid 2 | | compound | | | | |
| | | | liquid 1 | | | | |
| 26 | Toner base particle | 300 parts | Silicon | 9.94 | 3.5 | 60° C. | 15 |
| | dispersion liquid 3 | | compound | | | | |
| | | | liquid 1 | | | | |

TABLE 1-2

| | Second step | | | | | | Third step | | | | Washing step | |
|---|---|---|---|---|---|---|---|---|---|---|---|---|
| | | Amount | pH adjusting | | | | pH adjusting | | | | | Washing |
| Toner | | added | time | Adjusted | Temp- | Step time | time | Adjusted | Temp- | Step time | | time |
| No. | Additive | [parts] | [minutes] | pH | erature | [hours] | [minutes] | pH | erature | [hours] | pH | [minutes] |
| 1 | TC-315 | 1.05 | 30 | 9.0 | 50° C. | 5 | — | — | — | — | 1.5 | 15 |
| 2 | TC-315 | 0.58 | 30 | 8.0 | 50° C. | 1 | 30 | 10.0 | 50° C. | 4 | 1.5 | 15 |
| 3 | TC-315 | 0.58 | 30 | 8.0 | 45° C. | 1 | 1 | 10.0 | 45° C. | 4 | 1.5 | 15 |
| 4 | Silicon | 10.56 | 30 | 8.0 | 50° C. | 1 | 1 | 10.0 | 50° C. | 4 | 1.5 | 15 |
| | compound | | | | | | | | | | | |
| | liquid 1 | | | | | | | | | | | |
| 5 | TC-315 | 1.05 | 30 | 9.0 | 50° C. | 5 | — | — | — | — | 1.5 | 15 |
| 6 | TC-315 | 1.05 | 1 | 9.5 | 60° C. | 5 | — | — | — | — | 1.5 | 15 |
| 7 | TC-315 | 1.5 | 30 | 9.5 | 40° C. | 5 | — | — | — | — | 1.5 | 15 |
| 8 | TC-315 | 1.5 | 30 | 9.0 | 50° C. | 5 | — | — | — | — | 1.5 | 15 |
| 9 | TC-315 | 1.5 | 30 | 10.0 | 35° C. | 5 | — | — | — | — | 1.5 | 15 |
| 10 | TC-335 | 1.92 | 30 | 9.0 | 50° C. | 5 | — | — | — | — | 1.5 | 15 |
| 11 | TC-315 | 1.05 | 30 | 9.0 | 50° C. | 5 | — | — | — | — | 1.5 | 15 |
| 12 | TC-315 | 1.64 | 30 | 9.0 | 50° C. | 5 | — | — | — | — | 1.5 | 15 |
| 13 | TC-315 | 1.77 | 30 | 9.0 | 50° C. | 5 | — | — | — | — | 1.5 | 15 |
| 14 | Silicon | 7.39 | 1 | 8.0 | 50° C. | 1 | 1 | 10.0 | 50° C. | 4 | 1.5 | 15 |
| | compound | | | | | | | | | | | |
| | liquid 1 | | | | | | | | | | | |
| 15 | TC-315 | 0.84 | 30 | 9.0 | 60° C. | 5 | — | — | — | — | 1.5 | 15 |
| 16 | TC-315 | 1.58 | 30 | 8.0 | 45° C. | 1 | 1 | 9.5 | 50° C. | 4 | 1.5 | 15 |
| 17 | TC-315 | 1.58 | 30 | 10.0 | 30° C. | 5 | — | — | — | — | 1.5 | 15 |
| 18 | TC-315 | 1.05 | 30 | 10.0 | 35° C. | 5 | — | — | — | — | 1.5 | 15 |
| 19 | TC-315 | 0.73 | 30 | 9.0 | 40° C. | 5 | — | — | — | — | 1.5 | 15 |
| 20 | TC-315 | 0.34 | 30 | 8.0 | 50° C. | 1 | 30 | 10.0 | 50° C. | 4 | 1.5 | 15 |
| 21 | TC-315 | 1.48 | 1 | 10.0 | 50° C. | 5 | — | — | — | — | 1.5 | 15 |
| 22 | TC-315 | 0.45 | 30 | 8.0 | 50° C. | 1 | 30 | 10.0 | 50° C. | 4 | 1.5 | 15 |
| 23 | TC-315 | 1.82 | 1 | 10.0 | 45° C. | 5 | — | — | — | — | 1.5 | 60 |
| 24 | TA-30 | 0.5 | 30 | 9.0 | 50° C. | 5 | — | — | — | — | 1.5 | 15 |
| 25 | TC-315 | 0.82 | 30 | 8.0 | 55° C. | 1 | 30 | 9.5 | 55° C. | 4 | 1.5 | 60 |
| 26 | TC-315 | 1.05 | 30 | 9.0 | 50° C. | 5 | — | — | — | — | 1.5 | 15 |

In the Tables, the materials used as additives are as follows.
TC-315: titanium lactate (component concentration: 44% by mass) Matsumoto Fine Chemical Co., Ltd.
TC-335: titanium lactate ammonium salt (component concentration: 35% by mass) Matsumoto Fine Chemical Co., Ltd.
TA-30: titanium tetra-2-ethylhexoxide (component concentration: 99% by mass) Matsumoto Fine Chemical Co., Ltd.

TABLE 2

| | Toner | | | | | | | | | | | |
|---|---|---|---|---|---|---|---|---|---|---|---|---|
| Toner | particle | Type of Si | Type of Ti | Ti | Si | D1 | D4 | | Ti − E/ | | P_Ti/ | H |
| No. | No. | compound | compound | mmol | mmol | (μm) | (μm) | Ti − E | Si − E | M − X | P_Si | (nm) |
| 1 | 1 | MTMS | Ti lactate | 1.196 | 35.55 | 6.3 | 7.0 | 1.0E−02 | 3.0E−02 | 1.76E−02 | 0.07 | 60 |
| 2 | 2 | MTMS | Ti lactate | 1.495 | 26.02 | 6.3 | 7.0 | 1.0E−03 | 4.1E−02 | 1.93E−03 | 0.06 | 55 |
| 3 | 3 | MTMS | Ti lactate | 1.495 | 29.44 | 6.3 | 7.0 | 1.0E−03 | 1.1E−02 | 2.46E−03 | 0.06 | 54 |
| 4 | 4 | MTMS | Ti lactate | 1.495 | 38.76 | 6.3 | 7.0 | 1.3E−03 | 1.1E−02 | 2.29E−03 | 0.02 | 57 |
| 5 | 5 | MTMS | Ti lactate | 2.695 | 35.57 | 6.3 | 7.1 | 1.6E−02 | 6.9E−02 | 2.20E−03 | 0.06 | 58 |
| 6 | 6 | MTMS | Ti lactate | 2.718 | 38.76 | 6.4 | 7.0 | 1.2E−02 | 5.7E−02 | 2.11E−02 | 0.08 | 78 |
| 7 | 7 | MTMS | Ti lactate | 3.867 | 37.33 | 6.3 | 7.0 | 2.4E−02 | 6.9E−02 | 4.01E−02 | 0.08 | 27 |
| 8 | 8 | MTMS | Ti lactate | 3.867 | 35.57 | 6.3 | 7.2 | 2.3E−03 | 2.5E−02 | 5.53E−03 | 0.16 | 56 |
| 9 | 9 | MTMS | Ti lactate | 3.867 | 37.33 | 6.3 | 7.0 | 2.5E−02 | 7.0E−02 | 4.40E−02 | 0.17 | 27 |
| 10 | 10 | MTMS | Ti lactate | 4.961 | 35.55 | 6.3 | 7.0 | 9.6E−03 | 2.8E−02 | 1.78E−02 | 0.08 | 60 |
| | | | ammonium | | | | | | | | | |
| 11 | 11 | TEOS | Ti lactate | 2.718 | 31.81 | 6.3 | 7.0 | 9.7E−03 | 2.7E−02 | 1.78E−02 | 0.08 | 61 |
| 12 | 12 | MTMS | Ti lactate | 4.218 | 36.71 | 6.3 | 7.2 | 9.6E−03 | 2.7E−02 | 9.28E−02 | 0.14 | 61 |
| 13 | 13 | MTMS | Ti lactate | 4.57 | 36.71 | 6.3 | 7.2 | 9.8E−03 | 2.6E−02 | 1.02E−01 | 0.15 | 59 |
| 14 | 14 | MTMS | Ti lactate | 1.87 | 27.13 | 6.3 | 7.2 | 5.0E−03 | 6.8E−02 | 9.45E−02 | 0.02 | 59 |
| 15 | 15 | MTMS | Ti lactate | 2.168 | 43.72 | 6.4 | 7.2 | 5.0E−03 | 6.8E−02 | 9.45E−02 | 0.15 | 82 |
| 16 | 16 | MTMS | Ti lactate | 4.077 | 30.21 | 6.3 | 7.0 | 2.5E−02 | 7.0E−02 | 4.40E−02 | 0.06 | 42 |
| 17 | 17 | MTMS | Ti lactate | 4.077 | 30.21 | 6.2 | 7.0 | 2.5E−02 | 7.0E−02 | 4.40E−02 | 0.07 | 21 |
| 18 | 18 | MTMS | Ti lactate | 2.695 | 37.33 | 6.3 | 7.0 | 1.2E−02 | 1.0E−02 | 2.18E−02 | 0.10 | 28 |
| 19 | 19 | MTMS | Ti lactate | 1.875 | 33.73 | 6.3 | 7.0 | 5.0E−03 | 5.5E−02 | 3.30E−02 | 0.14 | 58 |
| 20 | 20 | MTMS | Ti lactate | 0.879 | 23.82 | 6.3 | 7.1 | 8.0E−04 | 1.4E−02 | 2.16E−03 | 0.02 | 56 |
| 21 | 21 | MTMS | Ti lactate | 3.808 | 35.55 | 6.3 | 7.1 | 2.4E−02 | 7.9E−02 | 3.42E−02 | 0.09 | 56 |
| 22 | 22 | MTMS | Ti lactate | 1.172 | 30.50 | 6.3 | 7.1 | 1.6E−03 | 9.7E−03 | 2.98E−03 | 0.05 | 58 |
| 23 | 23 | MTMS | Ti lactate | 4.687 | 36.71 | 6.3 | 7.1 | 2.8E−02 | 7.8E−02 | 4.71E−02 | 0.15 | 50 |
| 24 | 24 | MTMS | Ti alkoxide | 2.578 | 35.57 | 6.3 | 7.1 | 1.6E−02 | 6.9E−02 | 2.50E−03 | 0.07 | 56 |
| 25 | 25 | MTMS | Ti lactate | 2.109 | 35.57 | 6.3 | 7.1 | 1.6E−02 | 7.8E−02 | 1.95E−03 | 0.06 | 68 |
| 26 | 26 | MTMS | Ti lactate | 1.230 | 36.49 | 6.4 | 7.1 | 9.0E−04 | 6.0E−02 | 3.20E−03 | 0.15 | 78 |
| 27 | 27 | MTMS | Titanium | 0.563 | 35.56 | 6.3 | 7.1 | 1.1E−03 | 1.1E−02 | 9.27E−03 | 0.00 | 69 |
| | | | oxide | | | | | | | | | |
| | | | (25 nm) | | | | | | | | | |

For the toners 1 to 26, peaks were observed in a range of 900 cm⁻¹ to 1000 cm⁻¹ attributed to Ti—O—Si stretching vibration in the spectra obtained by infrared spectroscopy of silicon-titanium polymer composites.

In the table, Ti indicates the amount (mmol) of the Ti elements in the toner in relation to 100 g of the toner base particle. Si indicates the amount (mmol) of the Si elements in the toner in relation to 100 g of the toner base particle.

For example, the expression 1.0E-02 in the table represents 1.0×10⁻².

### Example 1

Each evaluation was performed using the toner 1 in the following evaluation device.

### Evaluation Device

The following two types of modified machines were used as evaluation devices.

As an image forming apparatus, a modified device 1, which was a modified device with a process speed of 268 mm/sec, modified such that a commercially available laser printer, LBP-722Ci (manufactured by Canon Inc.), was connected to an external high-voltage power supply to provide any potential difference between a charge blade and a developing roller, was used as an evaluation device 1.

As an image forming apparatus, a modified device 2, which was a modified device with a process speed of 90 mm/sec, modified such that a commercially available laser printer, LBP-722Ci (manufactured by Canon Inc.), was connected to an external high-voltage power supply to provide any potential difference between a charge blade and a developing roller, was used as an evaluation device 2.

As a process cartridge, a commercially available process cartridge, toner cartridge 064H (black) (manufactured by Canon Inc.) was used.

The product toner was removed from the inside of the cartridges, then the cartridge was cleaned by air blowing, and the cartridges for the evaluation devices 1 and 2 were filled with 600 g and 150 g of the toner to be evaluated, respectively. The position of the charge blade was adjusted such that the loading amount on the developing roller was 0.35 mg/cm³. In conducting the evaluation, yellow, magenta, and cyan cartridges were inserted into the yellow, magenta, and cyan stations, respectively, with the product toner removed and the remaining toner detection mechanism disabled.

### Evaluation of Durability Under Low Temperature and Low Humidity Environment

Two evaluation machines, the evaluation devices 1 and 2, were used for the evaluation. The body and cartridge mentioned above were left in a low temperature and low humidity environment (15.0° C./10% RH; hereafter referred to as LL environment) for 3 days. After leaving, the following evaluations were conducted.

The developing conditions were set at −500 V for the charge blade voltage and −300 V for the developing roller voltage. Under the LL environment, the intermittent operation stopping every time two images with a print ratio of 1% were output was repeated, and a total of 40,000 prints of the output test were performed for the evaluation device 1, and a total of 10,000 prints of the output test were performed for the evaluation device 2.

### Evaluation of Image Fog Under Low Temperature and Low Humidity Environment

The developing conditions were set at −500 V for the charge blade voltage and −300 V for the developing roller voltage.

The following evaluations were conducted at the initial stage and after the output test (after the durability test) in the durability evaluation.

The fog was evaluated using Letter-size HP ColorLaser Photographic Paper, Glossy (manufactured by Hewlett Packard Enterprise Co., 220 g/m²) as the printing paper, solid white images as the output images, and an unused drum unit prepared for image fog. The device was forced to stop during development, and the white image area latent on the drum (Dr) was taped with surface protection tape 331N (3M) and attached to Letter-size HP ColorLaser Photo Paper, Glossy (manufactured by Hewlett Packard Enterprise Co., 220 g/m²). As a non-image area, only the surface protective tape 331N (3M) was attached to the paper with the tape taped over the Dr.

For the evaluation of fog, the reflectance (%) was measured on the tape taped over Dr, in which the Green filter was set on the “REFLECTO METER MODEL TC-6DS” (manufactured by Tokyo Denshoku Co., Ltd.) and pasted on the paper. The evaluation was made based on the value (%) obtained by subtracting the obtained reflectance from the reflectance (%) of the tape attached as a non-image part measured in the same way. The smaller the value, the more suppressed the fog is.

The evaluation criteria are as follows.

### Evaluation Criteria

A: Subtracted value was less than 0.5%
B: Subtracted value was 0.5% or more and less than 1.5%
C: Subtracted value was 1.5% or more and less than 3.0%
D: Subtracted value was 3.0% or more

### Evaluation of Image Density Under Low Temperature and Low Humidity Environment

The developing conditions were set at −500 V for the charge blade voltage and −300 V for the developing roller voltage.

The following evaluations were conducted at the initial stage of the durability test, after 100 print outputs, and after the sheeting test (after the durability test).

For the evaluation of image density, GF-600 (read weight 60 g/m², Canon Marketing Japan Inc.) was used as the printing paper, and the output image was an image with a solid output of 5 cm×5 cm on the left, center and right sides of the leading edge of the paper, respectively.

Image density was measured using an X-Rite color reflectance densitometer (500 series: X-Rite, Inc.) to measure the image density of the solid image area and evaluated according to the following evaluation criteria.
A: The average of three points was 1.55 or more
B: The average of three points was 1.45 or more and less than 1.55
C: The average of three points was 1.35 or more and less than 1.45
D: The average of three points was less than 1.35

### Evaluation of Contamination of Members Under Low Temperature and Low Humidity Environment

The charge roller (C roller) was removed from the toner cartridge that had finished being evaluated in the evaluation device 1. The charge roller was removed from an unused process cartridge (commercially available one), the charge roller used in the durability test was installed, and a halftone image was output. The uniformity of the halftone image was visually evaluated to evaluate the contamination of charge members.

It is known that if the charge roller is contaminated, charging non-uniformity occurs on the photoreceptor drum, resulting in image density non-uniformity of the halftone image. C or higher was judged as good.

### Evaluation Criteria

A: Image density is not irregular and uniform
B: Image density is slightly irregular
C: Image density has some irregularity but is at a good level
D: Image density is irregular and at a level that does not form uniform halftone images.

### Evaluation of Durability Test Under High Temperature and High Humidity Environment

The evaluation device 1 was used as the evaluation device.

The body and cartridge mentioned above were left in a high temperature and high humidity environment (30.0° C./80% RH; hereafter referred to as HH environment) for 3 days. After leaving, the following evaluations were conducted. The developing conditions were set at −500 V for the charge blade voltage and −300 V for the developing roller voltage. A total of 10,000 output tests were conducted under the HH environment by continuously outputting images with a print percentage of 5%.

Evaluation of Fog under High Temperature and High Humidity Environment

The developing conditions were set at −500 V for the charge blade voltage and −300 V for the developing roller voltage.

The following evaluations were conducted at the initial stage of the durability test evaluation (fog after leaving for 3 days), after 100 print outputs, and after the outputting test (after the durability test).

The fog was evaluated using Letter-size HP ColorLaser Photographic Paper, Glossy (manufactured by Hewlett Packard Enterprise Co., 220 g/m²) as the printing paper, solid white images as the output images, and an unused drum unit prepared for image fog. The device was forced to stop during development, and the white image area latent on the Dr was taped with surface protection tape 331N (3M) and attached to Letter-size HP ColorLaser Photo Paper, Glossy (HP, 220 g/m²). As a non-image area, only the surface protective tape 331N (3M) was attached to the paper with the tape taped over the Dr.

For the evaluation of fog, the reflectance (%) was measured on the tape taped over Dr, in which the Green filter was set on the “REFLECTO METER MODEL TC-6DS” (manufactured by Tokyo Denshoku Co., Ltd.) and pasted on the paper. The evaluation was made based on the value (%) obtained by subtracting the obtained reflectance from the reflectance (%) of the tape attached as a non-image part measured in the same way. The smaller the value, the more suppressed the fog is.

The evaluation criteria are as follows.

### Evaluation Criteria

A: Subtracted value was less than 0.5%
B: Subtracted value was 0.5% or more and less than 1.5%
C: Subtracted value was 1.5% or more and less than 3.0%
D: Subtracted value was 3.0% or more
   Evaluation of Durability under Super-High-Temperature and High-Humidity Environment

An evaluation device 1 was used as the evaluation device.

The body and cartridge mentioned above were left in a Super-high temperature and high humidity environment (32.5° C./80% RH; hereafter referred to as SHH environment) for 3 days. After leaving, the following evaluations were conducted. The developing conditions were set at −500 V for the charge blade voltage and −300 V for the developing roller voltage. A total of 10,000 output tests were conducted under the SHH environment by continuously outputting images with a print percentage of 5%.

### Evaluation of Fog Under Super-High Temperature and Humidity Environment

The developing conditions were set at −500 V for the charge blade voltage and −300 V for the developing roller voltage.

The following evaluations were conducted at the initial stage of the durability test evaluation (fog after leaving for 3 days), after 100 print outputs, and after the outputting test (after the durability test).

The fog was evaluated using Letter-size HP ColorLaser Photographic Paper, Glossy (manufactured by Hewlett Packard Enterprise Co., 220 g/m²) as the printing paper, solid white images as the output images, and an unused drum unit prepared for image fog. The device was forced to stop during development, and the white image area latent on the Dr was taped with surface protection tape 331N (3M) and attached to Letter-size HP ColorLaser Photo Paper, Glossy (HP, 220 g/m²). As a non-image area, only the surface protective tape 331N (3M) was attached to the paper with the tape taped over the Dr.

For the evaluation of fog, the reflectance (%) was measured on the tape taped over Dr, in which the Green filter was set on the “REFLECTO METER MODEL TC-6DS” (manufactured by Tokyo Denshoku Co., Ltd.) and pasted on the paper. The evaluation was made based on the value (%) obtained by subtracting the obtained reflectance from the reflectance (%) of the tape attached as a non-image part measured in the same way. The smaller the value, the more suppressed the fog is.

The evaluation criteria are as follows.

### Evaluation Criteria

A: Subtracted value was less than 0.5%
B: Subtracted value was 0.5% or more and less than 1.5%
C: Subtracted value was 1.5% or more and less than 3.0%
D: Subtracted value was 3.0% or more

As indicated in Tables 3-1 and 3-2, the toner in Example 1 showed good results in all evaluations.

### Examples 2 to 19 and Comparative Examples 1 to 8

Examples 2 to 19 and Comparative Examples 1 to 8 were conducted on the combinations of toners listed in Tables 3-1 and 3-2. Tables 3-1 and 3-2 show the evaluation results.

TABLE 3-1

| | | Evaluation device | | | | | |
|---|---|---|---|---|---|---|---|
| | | Evaluation device 1 | | | | | |
| | | Environment | | | | | |
| | | | | | | LL | LL |
| | | LL | LL | | LL | Image | C roller |
| | | | Image | LL | Image | density | contamination |
| Example/ | | Initial | fog after | Initial | density | after | after |
| Comparative | | image | durability | image | after | durability | durability |
| Example | Toner | fog | test | density | 100 prints | test | test |
| Example 1 | Toner 1 | A | A | A | A | A | A |
| Example 2 | Toner 2 | A | B | A | A | A | A |
| Example 3 | Toner 3 | A | C | A | A | A | A |
| Example 4 | Toner 4 | A | C | B | A | A | A |
| Example 5 | Toner 5 | A | A | A | A | A | A |
| Example 6 | Toner 6 | A | A | A | A | A | B |
| Example 7 | Toner 7 | A | A | A | A | A | B |
| Example 8 | Toner 8 | A | B | A | A | A | A |
| Example 9 | Toner 9 | A | A | A | A | A | B |
| Example 10 | Toner 10 | A | A | A | A | A | A |
| Example 11 | Toner 11 | A | A | A | A | A | A |
| Example 12 | Toner 12 | A | A | B | B | B | A |
| Example 13 | Toner 13 | A | A | B | B | B | A |
| Example 14 | Toner 14 | A | A | A | A | A | B |
| Example 15 | Toner 15 | A | B | B | B | B | C |
| Example 16 | Toner 16 | A | A | A | A | A | A |
| Example 17 | Toner 17 | A | B | A | A | A | C |
| Example 18 | Toner 18 | A | B | A | A | A | B |
| Example 19 | Toner 19 | A | A | A | A | A | A |
| Comparative | Toner 20 | A | D | B | A | A | A |
| Example 1 | | | | | | | |
| Comparative | Toner 21 | A | A | B | A | A | A |
| Example 2 | | | | | | | |
| Comparative | Toner 22 | A | D | B | A | A | A |
| Example 3 | | | | | | | |
| Comparative | Toner 23 | A | A | A | A | A | A |
| Example 4 | | | | | | | |
| Comparative | Toner 24 | A | A | B | A | A | A |
| Example 5 | | | | | | | |
| Comparative | Toner 25 | A | A | A | A | A | A |
| Example 6 | | | | | | | |
| Comparative | Toner 26 | A | D | A | A | A | B |
| Example 7 | | | | | | | |
| Comparative | Toner 27 | A | D | D | B | A | B |
| Example 8 | | | | | | | |

TABLE 3-2

| | | Evaluation device | | | | | | | | | | |
|---|---|---|---|---|---|---|---|---|---|---|---|---|
| | | Evaluation device 2 | | | | | | | | | | |
| | | Environment | | | | | | | | | | |
| | | | | | | | | | HH | | | SHH |
| | | | | | | | | | Image | | | Image |
| | | | | | LL | LL | HH | HH | fog | SHH | SHH | fog |
| | | | LL | | Image | Image | Image | Image | after | Image | Image | after |
| | | LL | Image | LL | density | density | fog | density | leaving | fog | density | leaving |
| Example/ | | Initial | fog after | Initial | after | after | after | after | 3 days | after | after | 3 days |
| Comparative | | image | durability | image | 100 | durability | 100 | durability | (initial | 100 | durability | (initial) |
| Example | Toner | fog | test | density | prints | test | prints | test | fog) | prints | test | fog) |
| Example 1 | Toner 1 | A | A | A | A | A | A | A | A | A | A | A |
| Example 2 | Toner 2 | A | B | A | A | A | A | A | A | A | A | A |
| Example 3 | Toner 3 | A | B | A | A | A | A | A | A | A | A | A |
| Example 4 | Toner 4 | A | B | B | A | A | A | A | A | A | A | A |
| Example 5 | Toner 5 | A | B | A | A | A | A | A | A | A | A | B |
| Example 6 | Toner 6 | A | A | A | A | A | A | A | A | A | A | A |
| Example 7 | Toner 7 | A | A | A | A | A | A | A | B | B | B | C |
| Example 8 | Toner 8 | A | B | B | A | A | A | A | A | A | A | A |
| Example 9 | Toner 9 | A | A | B | A | A | A | A | B | B | B | C |
| Example 10 | Toner 10 | A | A | A | A | A | A | A | A | A | A | A |
| Example 11 | Toner 11 | A | A | A | A | A | A | A | A | A | A | A |
| Example 12 | Toner 12 | A | A | B | B | B | A | A | A | A | A | A |
| Example 13 | Toner 13 | A | A | B | B | B | A | A | A | A | A | A |
| Example 14 | Toner 14 | A | B | A | A | A | A | A | A | A | A | B |
| Example 15 | Toner 15 | A | B | B | B | B | A | A | A | A | A | B |
| Example 16 | Toner 16 | A | A | A | A | A | A | A | B | B | B | C |
| Example 17 | Toner 17 | A | A | A | A | A | A | A | B | B | B | C |
| Example 18 | Toner 18 | A | A | A | A | A | A | A | A | A | A | A |
| Example 19 | Toner 19 | A | A | A | A | A | A | A | A | A | A | A |
| Comparative | Toner 20 | A | D | B | A | A | A | A | A | A | A | A |
| Example 1 | | | | | | | | | | | | |
| Comparative | Toner 21 | A | A | B | A | A | B | A | D | B | A | D |
| Example 2 | | | | | | | | | | | | |
| Comparative | Toner 22 | A | C | B | A | A | A | A | A | A | A | A |
| Example 3 | | | | | | | | | | | | |
| Comparative | Toner 23 | A | A | A | A | A | D | D | D | D | D | D |
| Example 4 | | | | | | | | | | | | |
| Comparative | Toner 24 | A | A | C | B | A | B | C | D | B | C | D |
| Example 5 | | | | | | | | | | | | |
| Comparative | Toner 25 | A | A | A | A | A | B | A | D | B | A | D |
| Example 6 | | | | | | | | | | | | |
| Comparative | Toner 26 | A | C | D | B | A | A | A | A | A | A | C |
| Example 7 | | | | | | | | | | | | |
| Comparative | Toner 27 | A | C | D | B | A | A | A | A | A | A | C |
| Example 8 | | | | | | | | | | | | |

### Production Example of Toner Particle 28

The pH of the toner base particle dispersion liquid 1 was adjusted to 1.5 with 1 mol/L hydrochloric acid, the mixture was stirred for 1.5 minutes, and then filtered while washing with ion exchange water to obtain a toner particle 28. The number-average particle diameter (D1) of the toner particle 28 was 6.2 μm, and the volume-average particle diameter (D4) was 6.9 μm.

### Production Example of Silicon-Titanium Polymer Fine Particle 1 First Step

An aqueous solution containing 1.0 part of sodium phosphate (dodecahydrate) was prepared in a reaction vessel containing 100.0 parts of ion exchange water, and the pH thereof was adjusted to 3.0 with 1 mol/L HCl.

While mixing the aqueous solution in the reaction vessel with a propeller stirring blade, 0.95 parts of 44% aqueous titanium lactate solution (TC-315: manufactured by Matsumoto Fine Chemical Co., Ltd.) was fed, and 15 minutes later, 8.34 parts of the silicon compound liquid 1 was fed. Next, the reaction vessel temperature was set to 50° C., and the pH was adjusted to 8.5 using 1 mol/L NaOH over 30 minutes and stirred for 2 hours.

### Second Step

Two hours later, the pH of the mixed liquid was adjusted to 9.5 using a 1-mol/L aqueous NaOH solution, and a solution containing a mixture of 0.10 parts of TC-315 and 1.00 part of a silicon compound liquid was added dropwise to the mixed liquid being mixed using a propeller stirring blade over 30 minutes. After that, the mixture was kept stirred for 3.0 hours.

Next, a silicon-titanium polymer particle 1 with a number-average particle diameter of 45 nm was obtained by lowering the temperature to 25° C., followed by filtration while washing with ion exchange water. Table 5 shows the physical properties of the obtained silica-titanium polymer fine particle 1.

### Production Examples of Silicon-Titanium Polymer Fine Particles 2 to 4

Silicon-titanium polymer fine particles 2 to 4 were prepared in the same manner as the silicon-titanium polymer fine particle 1, except that type and amount of the material in each step in the production example of the silicon-titanium polymer fine particle 1 were changed to those listed in table 4. Table 5 shows the properties of the obtained silicon-titanium polymers 2 to 4.

### Production Example of Silicon-Titanium Polymer Fine Particle 5

A solution containing 0.045 parts of titanium dioxide with a number average particle diameter of 25 nm dispersed in 100 parts of distilled water and adjusted to a pH of 9.0 with a 1-mol/L aqueous NaOH solution and a temperature of 50° C. was prepared using CLEARMIX. Then, 6.55 parts of the silicon compound liquid 1 was added dropwise over 30 minutes while stirring the dispersion liquid with a propeller stirring blade, and the dispersion liquid was kept at 50° C. for 5 hours to obtain a slurry of a silicon-titanium polymer fine particle 5.

A silicon-titanium composite particle 5 with a number-average particle diameter of 45 nm was obtained by lowering the temperature of the slurry to 25° C., followed by filtration while washing with ion exchange water. Table 5 shows the physical properties of the obtained silicon-titanium polymer fine particle 5.

TABLE 4

| Production | First step | | | | | | | |
|---|---|---|---|---|---|---|---|---|
| Example of | | Amount | | Amount | | Amount | | |
| Si—Ti | | of base | | of | | of | | Step |
| polymer fine | Additive | particle | Additive | additive | Additive | additive | Temp- | time |
| particle | 1 | added | 2 | added | 3 | added | erature | [hours] |
| Si—Ti | Sodium | 1.0 | TC-315 | 0.95 | Silicon | 8.34 | 50° C. | 2 |
| polymer fine | phosphate | part | | parts | compound | parts | | |
| particle 1 | | | | | liquid 1 | | | |
| Si—Ti | Sodium | 1.0 | TC-315 | 0.95 | Silicon | 5.71 | 50° C. | 2 |
| polymer fine | phosphate | part | | parts | compound | parts | | |
| particle 2 | | | | | liquid 1 | | | |
| Si—Ti | Sodium | 1.0 | TC-315 | 0.95 | Silicon | 8.83 | 50° C. | 2 |
| polymer fine | phosphate | part | | parts | compound | parts | | |
| particle 3 | | | | | liquid 1 | | | |
| Si—Ti | Sodium | 1.0 | TC-315 | 0.95 | Silicon | 9.08 | 50° C. | 2 |
| polymer fine | phosphate | part | | parts | compound | parts | | |
| particle 4 | | | | | liquid 1 | | | |
| Si—Ti | Titanium | 0.045 | Silicon | 6.55 | | | 50° C. | 2 |
| polymer fine | oxide | parts | compound | parts | | | | |
| particle 5 | | | liquid 1 | | | | | |
| | Second step | | | | | | | |
| Production | | | | | | | | |
| Example of | | Amount | | Amount | | | | |

| | | |
|---|---|---|
| Si—Ti | of base | of |

| polymer fine | Additive | particle | Additive | additive | | Steptime |
|---|---|---|---|---|---|---|
| particle | 2 | added | 3 | added | Temperature | [hours] |
| Si—Ti | TC-315 | 0.10 | Silicon | 1.00 | 50° C. | 3 |
| polymer fine | | part | compound | part | | |
| particle 1 | | | liquid 1 | | | |
| Si—Ti | TC-315 | 0.10 | Silicon | 1.00 | 50° C. | 3 |
| polymer fine | | part | compound | part | | |
| particle 2 | | | liquid 1 | | | |
| Si—Ti | TC-315 | 0.10 | Silicon | 1.00 | 50° C. | 3 |
| polymer fine | | part | compound | part | | |
| particle 3 | | | liquid 1 | | | |
| Si—Ti | TC-315 | 0.10 | Silicon | 1.00 | 50° C. | 3 |
| polymer fine | | part | compound | part | | |
| particle 4 | | | liquid 1 | | | |
| Si—Ti | — | — | — | — | — | — |
| polymer fine | | | | | | |
| particle 5 | | | | | | |

### Production Example of Toner 28

Toner particle 28:100 parts
Silicon-titanium polymer fine particle 1:5 parts

The material mentioned above was dry-mixed for 10 minutes with a Henschel mixer (manufactured by Nippon Coke & Engineering Co., Ltd.) to produce a toner 28. Table 5 shows the properties of the obtained toner 28.

### Production Examples of Toners 29 to 32

Toners 29 to 32 were prepared in the same manner as in the production example of the toner 28, except that the silicon-titanium polymer fine particle 1 in the production example of the toner 28 was changed to the fine particle listed in Table 5. Table 5 shows the properties of the obtained toners 29 to 32.

TABLE 5

| | Toner | External | D1 | D4 | | TI-E/ | | P_Ti/ | H |
|---|---|---|---|---|---|---|---|---|---|
| Toner | particle | additive | (μm) | (μm) | TI − E | Si-E | M − X | P_Si | (nm) |
| Toner 28 | Toner | Si—Ti | 6.2 | 7.0 | 1.0E−02 | 3.0E−02 | 1.78E−02 | 0.06 | 45 |
| | particle 28 | polymer fine | | | | | | | |
| | | particle 1 | | | | | | | |
| Toner 29 | Toner | Si—Ti | 6.2 | 7.0 | 1.1E−02 | 5.1E−02 | 3.24E−02 | 0.06 | 29 |
| | particle 28 | polymer fine | | | | | | | |
| | | particle 2 | | | | | | | |
| Toner 30 | Toner | Si—Ti | 6.2 | 7.0 | 9.8E−03 | 2.6E−02 | 1.65E−02 | 0.06 | 58 |
| | particle 28 | polymer fine | | | | | | | |
| | | particle 3 | | | | | | | |
| Toner 31 | Toner | Si—Ti | 6.2 | 7.0 | 9.5E−03 | 2.0E−02 | 1.54E−02 | 0.06 | 73 |
| | particle 28 | polymer fine | | | | | | | |
| | | particle 4 | | | | | | | |
| Toner 32 | Toner | Si—Ti | 6.2 | 7.0 | 1.1E−03 | 1.1E−02 | 9.27E−03 | 0.00 | 45 |
| | particle 28 | polymer fine | | | | | | | |
| | | particle 5 | | | | | | | |

In the toners 28 to 31, peaks were observed in a range of 900 cm⁻¹ to 1000 cm⁻¹ attributed to Ti—O—Si stretching vibration in the spectra obtained by infrared spectroscopy of fine particles of the silicon-titanium polymer composite.

In the table, H denotes the number-average particle size of the silicon-titanium polymer fine particle.

### Example A

The following evaluations were conducted in a similar manner to Example 1. The toner of Example A showed good results. Tables 6-1, 6-2, and 6-3 show detailed evaluation results.

### Examples B to D and Comparative Example A

The following evaluations were made in a similar manner to Example 1. Tables 6-1, 6-2, and 6-3 show detailed evaluation results.

TABLE 6-1

| | | Evaluation device | | | | | |
|---|---|---|---|---|---|---|---|
| | | Evaluation device 1 | | | | | |
| | | Environment | | | | | |
| | | | | | LL | LL | LL |
| | | | LL | | Image | Image | C roller |
| | | LL | Image | LL | density | density | contamination |
| Example/ | | Initial | fog after | Initial | after | after | after |
| Comparative | | image | durability | image | 100 | durability | durability |
| Example | Toner | fog | test | density | prints | test | test |
| Example A | Toner 28 | A | A | A | A | A | B |
| Example B | Toner 29 | A | B | A | A | A | A |
| Example C | Toner 30 | A | A | A | A | A | C |
| Example D | Toner 31 | A | A | A | A | A | C |
| Comparative | Toner 32 | A | D | D | B | A | B |
| Example A | | | | | | | |

TABLE 6-2

| | | Evaluation device | | | | |
|---|---|---|---|---|---|---|
| | | Evaluation device 2 | | | | |
| | | Environment | | | | |
| | | | LL | | LL | LL |
| | | | Image | | Image | Image |
| | | LL | fog | LL | density | density |
| Example/ | | Initial | after | Initial | after | after |
| Comparative | | image | durability | image | 100 | durability |
| Example | Toner | fog | test | density | prints | test |
| Example A | Toner 28 | A | A | A | A | A |
| Example B | Toner 29 | A | A | A | A | A |
| Example C | Toner 30 | A | A | A | A | A |
| Example D | Toner 31 | A | A | A | A | A |
| Comparative | Toner 32 | A | C | D | B | A |
| Example A | | | | | | |

TABLE 6-3

| | | Evaluation device | | | | | |
|---|---|---|---|---|---|---|---|
| | | Evaluation device 2 | | | | | |
| | | Environment | | | | | |
| | | | | HH | | | |
| | | | HH | Image | | SHH | SHH |
| | | HH | Image | fog | SHH | Image | fog |
| | | Image | fog | after | Image | fog | after |
| Example/ | | fog | after | leaving | fog | after | leaving |
| Com- | | after | dura- | 3 days | after | dura- | 3 days |
| parative | | 100 | bility | (Initial | 100 | bility | (Initial |
| Example | Toner | prints | test | fog) | prints | test | fog) |
| Example A | Toner 28 | A | A | A | A | A | A |
| Example B | Toner 29 | A | A | A | A | A | A |
| Example C | Toner 30 | A | A | A | A | A | A |
| Example D | Toner 31 | A | A | A | A | A | A |
| Com- | Toner 32 | A | A | A | A | A | C |
| parative | | | | | | | |
| Example A | | | | | | | |

while the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-151562, filed Sep. 19, 2023, which is hereby incorporated by reference herein in its entirety.

What is claimed is:

1. A toner comprising a toner particle,
the toner particle comprising:
a toner base particle that comprises a binder resin and a colorant; and
a silicon-titanium polymer composite existing at a surface of the toner base particle,
the silicon-titanium polymer composite comprising a silicon polymer segment and a titanium chelate segment,
the silicon-titanium polymer composite having a peak within a range of 900 cm⁻¹ to 1000 cm⁻¹ attributed to Ti—O—Si stretching vibration in a spectrum obtained by infrared spectroscopy,
when a proportion of the number of the titanium atom in a sum of the numbers of a carbon atom, an oxygen atom, a silicon atom, a phosphorous atom, and the titanium atom obtained by X-ray photoelectron spectroscopy on the toner is defined as Ti-E, and a proportion of the number of the silicon atom in a sum of the numbers of a carbon atom, an oxygen atom, a silicon atom, a phosphorous atom, and the titanium atom obtained by X-ray photoelectron spectroscopy on the toner is defined as Si-E,
the Ti-E and the Si-E satisfying Formulae (1) and (2) below:
$$1.0 \times 1 {0}^{- 3} \leq Ti - E \leq 2.5 \times 1 {0}^{- 2} \qquad ( 1 )$$
$$1. \times 1 {0}^{- 2} \leq Ti - E / Si - E \leq 7.0 \times 1 {0}^{- 2} . \qquad ( 2 )$$

2. The toner according to claim 1, wherein a titanium chelate in the titanium chelate segment comprises at least one titanium chelate selected from the group consisting of a titanium phosphate chelate, titanium lactate, titanium lactate ammonium salt, titanium dodecylbenzenesulphonate, titanium acetylacetonate, titanium tetra(acetylacetonate), titanium ethylacetoacetate, and titanium octyleneglycolate.

3. The toner according to claim 1, wherein a titanium chelate in the titanium chelate segment comprises at least one titanium chelate selected from the group consisting of titanium phosphate, titanium lactate, titanium lactate ammonium salt, and titanium dodecylbenzenesulphonate.

4. The toner according to claim 1, wherein in an EDS mapping image of constituent elements of a cross-section of the toner obtained by analyzing with use of energy dispersive X-ray spectroscopy, the cross-section of the toner observed with a transmission electron microscope,
when a proportion of the number of titanium atoms in a sum of the numbers of atoms of silicon atoms and titanium atoms in a region outside an outline of the toner base particle is defined as M-X, the M-X satisfies Formula (3):
$$0.50 \times 1 {0}^{- 4} \leq M - X \leq 1.5 \times 1 {0}^{- 1} . \qquad ( 3 )$$

5. The toner according to claim 1, wherein in a spectrum obtained by infrared spectroscopy of the silicon-titanium polymer composite, when a maximum value of a peak within a range of 900 cm⁻¹ to 1000 cm⁻¹ attributed to Ti—O—Si stretching vibration is defined as P_Ti, and
a maximum of a peak within a range of 1000 cm⁻¹ to 1100 cm⁻¹ attributed to Si—O—Si stretching vibration is defined as P_Si,
the P_Ti and the P_Si satisfy Formula (4) below:
$$0.06 \leq P\_Ti / P\_Si \leq 0 \text{.15} . \qquad ( 4 )$$

6. The toner according to claim 1, wherein the silicon-titanium polymer composite fixes on a surface of the toner base particle in a protruded shape, and
when a number average height of a protruded portion measured by a scanning probe microscope is defined as H,
the H is 25 to 100 nm.

7. The toner according to claim 1, wherein the silicon polymer segment is a condensation polymerization product of an organic silicon compound.

8. The toner according to claim 1, wherein the silicon polymer segment comprises a structure represented by Formula (5) below:
R—SiO_{3/2} (5)
in Formula (5), R is a C1-6 alkyl group or a phenyl group.

9. A toner comprising a toner particle that comprises a binder resin and a colorant, and a fine particle of a silicon-titanium polymer composite,
the silicon-titanium polymer composite comprising a silicon polymer segment and a titanium chelate segment,
the silicon-titanium polymer composite having a peak within a range of 900 cm⁻¹ to 1000 cm⁻¹ attributed to Ti—O—Si stretching vibration in a spectrum obtained by infrared spectroscopy, and
when a proportion of the number of titanium atoms in a sum of the numbers of carbon atoms, oxygen atoms, silicon atoms, phosphorous atoms, and titanium atoms obtained by X-ray photoelectron spectroscopy on the toner is defined as Ti-E, and a proportion of the number of silicon atoms in a sum of the numbers of carbon atoms, oxygen atoms, silicon atoms, phosphorous atoms, and titanium atoms obtained by X-ray photoelectron spectroscopy on the toner is defined as Si-E,
the Ti-E and the Si-E satisfying Formulae (1) and (2) below:
$$1.0 \times 1 {0}^{- 3} \leq Ti - E \leq 2.5 \times 1 {0}^{- 2} \qquad ( 1 )$$
$$1. \times 1 {0}^{- 2} \leq Ti - E / Si - E \leq 7.0 \times 1 {0}^{- 2} \qquad ( 2 )$$
